(19) United States
(12) Patent Application Publication
(10) Pub. No.: US 2026/0067966 A1
(43) Pub. Date: Mar. 5, 2026

(54) DYNAMIC FRAME SIZE ADAPTATION FOR ENHANCED AIRTIME UTILIZATION

(71) Applicant: Apple Inc., Cupertino, CA (US)

(72) Inventors: Sarvesh Kumar VARATHARAJAN, Milpitas, CA (US); Yaranama Venkata Ramana DASS, Belmont, CA (US); Venkateswara Rao MANEPALLI, San Jose, CA (US); Paul V. FLYNN, Menlo Park, CA (US); Arun Vijayakumari MAHASENAN, Fremont, CA (US)

(21) Appl. No.: 19/267,474

(22) Filed: Jul. 11, 2025

Related U.S. Application Data
(60) Provisional application No. 63/687,723, filed on Aug. 27, 2024.
(60) Provisional application No. 63/687,725, filed on Aug. 27, 2024.

(51) Int. Cl. H04W 76/15

(52) U.S. Cl. CPC H04W 76/15

(57) ABSTRACT

The subject technology provides for dynamic frame size adaptation. An apparatus may apply a frame size adaptation to a resource allocation associated with a first wireless communication protocol based on a coexistence between activity associated with the first wireless communication protocol and activity associated with a second wireless communication protocol different than the first wireless communication protocol on a shared frequency band. The apparatus also may monitor for reception of a data transmission associated with the first wireless communication protocol on the shared frequency band based at least in part on the frame size adaptation. By dynamically adapting the frame size, the reliability of transmissions in a mesh network is increased and coexistence between radios sharing the same frequency band can be improved.

### CROSS-REFERENCE TO RELATED APPLICATION(S)

This application claims the benefit of U.S. Provisional Application Ser. No. 63/687,723, entitled “DYNAMIC FRAME SIZE ADAPTATION FOR ENHANCED AIRTIME UTILIZATION,” and filed on Aug. 27, 2024, and U.S. Provisional Application Ser. No. 63/687,725, entitled “DYNAMIC FRAME SIZE ADAPTATION FOR ENHANCED AIRTIME UTILIZATION,” and filed on Aug. 27, 2024, the disclosures of which are expressly incorporated by reference herein in their entirety.

### TECHNICAL FIELD

The present description generally relates to wireless communication systems and, in particular to, dynamic frame size adaptation for device-to-device wireless communications.

### BACKGROUND

A mesh network may include router devices to forward packets between end devices of the network. That is, the end devices communicate with a corresponding router of the network but may not forward packets for other network devices. In this way, the router may act as a parent device for the end devices. End devices wake and poll their parent device.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 conceptually illustrates an example of a system for performing signaling between a coexistence-constrained device and a non-coexistence-constrained device in a mesh network in accordance with one or more implementations.

FIG. 3A is a schematic diagram illustrating an example frame exchange between a coexistence-constrained device and a non-coexistence-constrained device in accordance with one or more implementations.

FIG. 3B is a schematic diagram illustrating an example frame exchange with dynamic frame size adaptation between a coexistence-constrained device and a non-coexistence-constrained device in accordance with one or more implementations.

FIGS. 4A-4C are schematic diagrams of different examples of dynamic frame size adaptation between a coexistence-constrained device and a non-coexistence-constrained device in accordance with one or more implementations.

FIG. 5 is a schematic diagram illustrating an example dynamic frame size adaptation procedure between a coexistence-constrained device and multiple non-coexistence-constrained devices in accordance with one or more implementations.

FIG. 6 is a schematic diagram illustrating an example fragmentation header in accordance with one or more implementations.

FIG. 7 is a schematic diagram illustrating an example dynamic frame size adaptation procedure between multiple coexistence-constrained devices in accordance with one or more implementations.

FIG. 8 is a flow chart of an example process of an example dynamic frame size adaptation procedure based on audio loss feedback in accordance with one or more implementations.

FIG. 9 is a schematic diagram illustrating an example process for dynamic frame size adaptation by a coexistence-constrained device in accordance with one or more implementations.

FIG. 10 is a schematic diagram illustrating an example process for dynamic frame size adaptation by a non-coexistence-constrained device in accordance with one or more implementations.

FIG. 11 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

The present disclosure relates to enabling communication between end devices of a network. In some cases, communication may be enabled via a temporary connection (e.g., on an on-demand and/or as-needed basis). Specifically, the network may include a mesh network and the communication between devices may be in accordance a mesh network communication protocol. For example, the mesh network communication protocol may utilize a router to forward packets between end devices of the mesh network. That is, the router may act as a parent device for the end devices. The parent device may provide connectivity and manage communication with the end devices. As such, an end device may utilize a radio to transmit a message to another end device, e.g., over the mesh network, via the router. In other examples, end devices may communicate with each other over the mesh network without a router. In one example, the router may forward information between the mesh network and a non-mesh network, such as a Wi-Fi network. In that case, the router may be referred to as a “border router” and convert a Wi-Fi message to the mesh network communication protocol and transmit the converted mesh network message to the target end device using a mesh network radio.

In one or more implementations, a mesh network router in accordance with the IEEE 802.15.4 can support low-rate wireless personal area networks (LR-WPANs), designed for short-distance communication with low power consumption. The mesh network router may be employed in a scalable mesh network topology where each node can relay data to extend coverage. The mesh network router may support low data rates up to 250 kbps, suitable for applications like sensor networks. In one or more other implementations, a Wi-Fi router may be employed in a star topology, which uses a central access point. The Wi-Fi router may support high data rates, up to several gigabits-per-second (Gbps), for bandwidth-intensive applications. The Wi-Fi router may provide long-distance ranges per node independent of any inherent mesh networking.

In one or more implementations, the end devices may be sleepy end devices (SEDs), which are normally disabled (e.g., asleep) and wake on occasion to poll for messages from a parent device (e.g., the router). In this regard, SEDs can include battery-powered accessories that exhibit intermittent radio functionality due to resource or battery constraints. In one or more implementations, an SED may awaken when a “wakeup message” is received. For example, the router may transmit the wakeup message to the SED. The wakeup message may instruct the SED to wake-up to poll for messages at a time different than a schedule polling period. In one or more implementations, the end devices may continue to operate as synchronized sleepy end devices (SSEDs) and use coordinated sampled listening (CSL) techniques to communicate (e.g., via the mesh network communication protocol).

When an electronic device integrates into a mesh network, the electronic device may function as a coexistence-constrained device (CCD) because of its multiple radios, including Bluetooth, Wi-Fi, and mesh network radios, operating in a designated frequency spectrum (e.g., 2.4 gigahertz (GHz) band or the like). Concurrent operation of these radios introduces challenges due to coexistence constraints. In one or more implementations, coexistence refers to the ability of multiple wireless communication systems to operate in the same frequency bands without causing significant interference to each other. Conversely, a non-coexistence-constrained device may operate with fewer radios or within different frequency bands, thus avoiding the coexistence challenges faced by coexistence-constrained devices. In one or more implementations, the coexistence-constrained device can assume roles such as SED, SSED, full end device (FED), sleepy router, router, or leader node. Additionally, the coexistence-constrained device may function as a border router.

In one or more implementations, a coexistence-constrained device functioning as a transmitter can independently adapt a frame size. However, a coexistence-constrained device acting as a receiver may not control the frame size of the transmitter on the other end without employing a negotiation scheme. This lack of control can affect the receiver's ability to manage frame sizes efficiently during data transmission. In one or more implementations, the maximum frame size may be fixed at 127 bytes. This frame size translates to approximately 5 milliseconds (ms) of air-time utilization by both a transmitter and a receiver. This duration may account for the time required for the complete transmission and reception of a frame within defined parameters of the IEEE 802.15.4 standard.

In one or more implementations, the operation of electronic devices in the 2.4 GHz frequency band, for example, can result in shared radio resources between different wireless communication protocols (e.g., mesh network, Bluetooth, Wi-Fi), which operate in the same overlapping frequencies. This overlap necessitates efficient management of radio resources to minimize interference and ensure reliable communication among these technologies. In one or more implementations, in coexistence-challenged scenarios, a coexistence-constrained device may not obtain a contiguous duration (e.g., 5 ms) of exclusive access to radio resources necessary to complete the transmission or reception of a 127-byte frame. This limitation can lead to the corruption of data packets associated with different wireless communication protocols (e.g., mesh network, Bluetooth, Wi-Fi) due to overlapping use of the same radio frequencies.

Embodiments of the subject technology provide for dynamic frame size adaptation. In one or more implementations, the coexistence-constrained device may dynamically adapt a frame size based on its coexistence conditions and shares the dynamically adapted frame size with neighboring devices. A neighboring device (e.g., a non-coexistence-constrained device or a coexistence-constrained device) may limit its maximum frame size to the negotiated frame size value. This adaptation and communication facilitate efficient use of shared radio resources while maintaining network performance.

In one or more implementations, an apparatus may apply a frame size adaptation to a resource allocation associated with a first wireless communication protocol based on a coexistence between activity associated with the first wireless communication protocol and activity associated with a second wireless communication protocol different than the first wireless communication protocol on a shared frequency band. The apparatus also may monitor for reception of a data transmission associated with the first wireless communication protocol on the shared frequency band based at least in part on the frame size adaptation. By dynamically adapting the frame size, the reliability of transmissions in a mesh network is increased and coexistence between radios sharing the same frequency band can be improved.

In one or more other implementations, an apparatus may receive, from a coexistence-constrained device, an indication indicating a frame size adaptation to a resource allocation associated with a first wireless communication protocol based on a coexistence between activity associated with the first wireless communication protocol and activity associated with a second wireless communication protocol different than the first wireless communication protocol on a shared frequency band. The apparatus also may facilitate a data transmission associated with the first wireless communication protocol with the coexistence-constrained device on the shared frequency band based at least in part on the frame size adaptation.

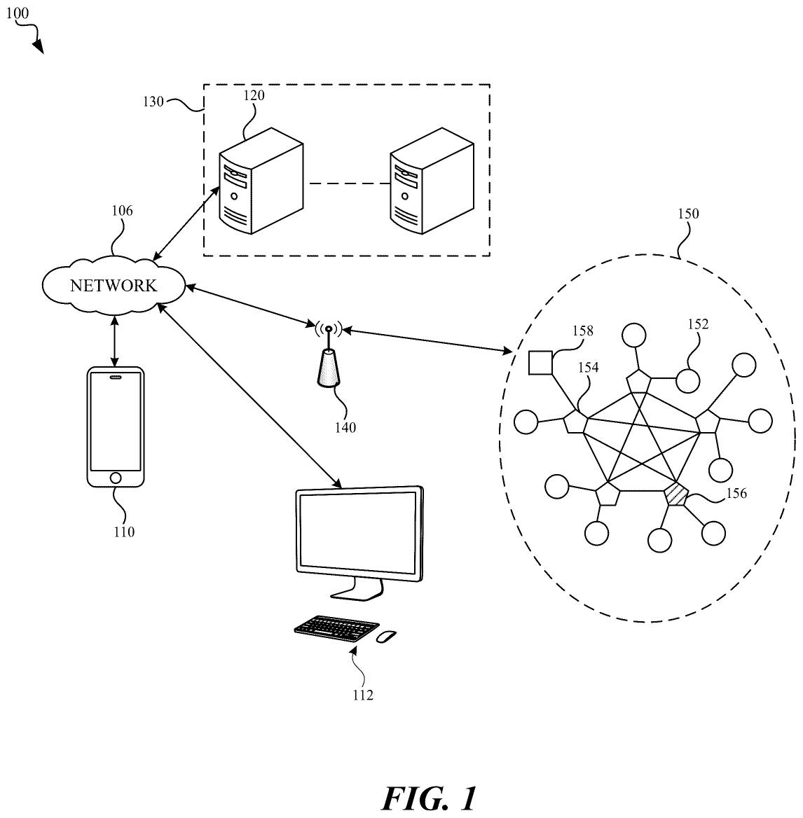

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The following description is provided for the network environment 100 that operates in conjunction with the IEEE 802.15.4 standards for LR-WPANs. It should be understood that the concepts disclosed herein may also be applied to other networks, including Thread®, Zigbee®, Z-Wave®, Bluetooth Low Energy (BLE), ISA100.11a, WirelessHART®, MiWi™, IPV6 over Low-Power Wireless Personal Area Networks (6LoWPAN), Subnetwork Access Protocol (SNAP), Wi-Fi mesh networks, and the like.

The network environment 100 includes an electronic device 110, an electronic device 112, a server 120, an access point 140 and a mesh network 150. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, and the server 120; however, the network environment 100 may include any number of electronic devices and any number of servers or a data center including multiple servers.

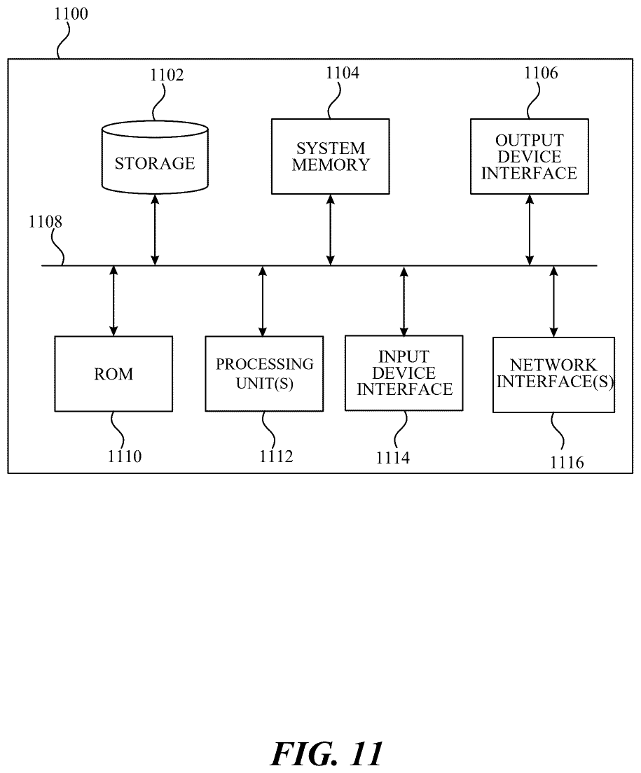

The electronic device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 11.

The electronic device 112 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 112 is depicted as a desktop computer. The electronic device 112 may be, and/or may include all or part of, the electronic system discussed below with respect to FIG. 11.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users.

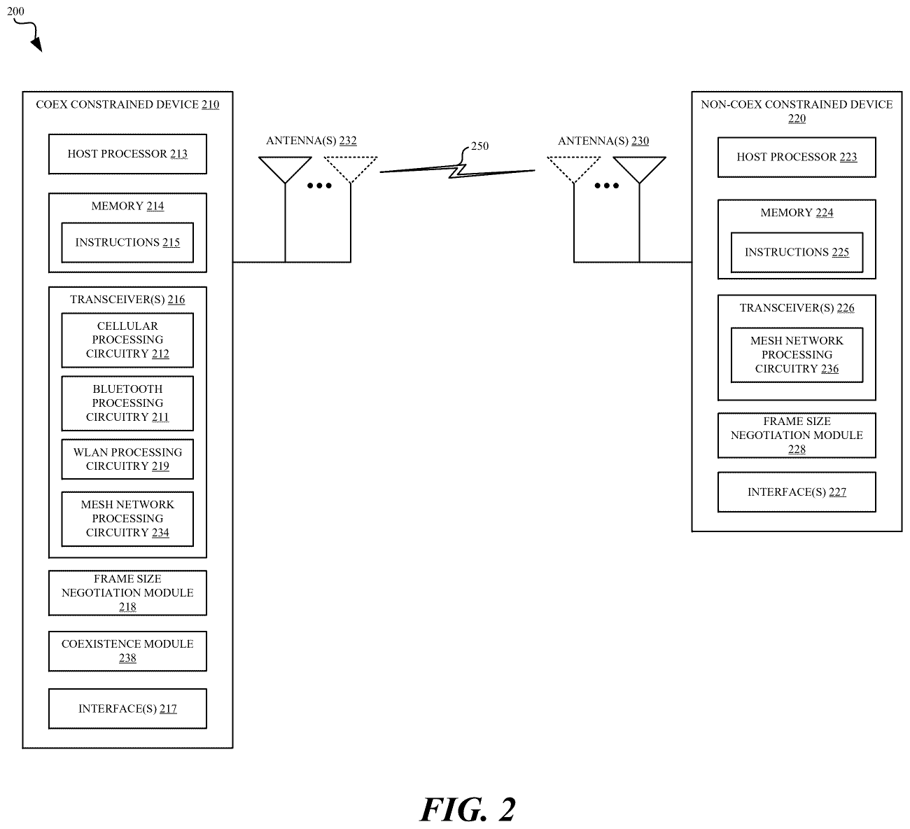

The mesh network 150 includes various end devices 152 and routers 154 (each of which may include any one of the electronic devices 110-112 of FIG. 1). In one or more implementations, the routers 154 (represented as pentagons) may forward packets (e.g., data) between and/or to the end devices 152 (represented as circles) of the mesh network 150. A router 154 may transmit a packet via a radio or transceiver, such as the transceiver 226 of FIG. 2, to a targeted end device 152 via another router 154. The routers 154 may also provide secure commissioning services for other devices attempting to join the mesh network 150. The transceiver 226 of each router 154 may be enabled at times for a specified duration to receive and transmit packets.

If a router 154 does not have any child devices (e.g., communicatively coupled end devices 152), the router 154 may be downgraded and/or configured to operate as an end device 152. Conversely, if a new end device attempting to join the mesh network 150 is within range of a current end device 152 of the mesh network 150 (but not a router 154), and that end device 152 is eligible to become a router 154, the end device 152 may be upgraded and/or configured to operate as a router 154 for the new end device. In that case, the new router 154 acts as a router 154 with respect to the new end device and is coupled to one or more other routers 154 of the mesh network 150.

Each end device 152 of the mesh network 150 may communicate primarily with a single router 154. For example, the end devices 152 may not forward packets for other network devices (e.g., end devices 152 and router 154). In one or more implementations, the end devices 152 are SEDs and may disable their respective transceivers (e.g., in the form of the transceiver 216 of FIG. 2) to reduce power consumption. In such cases, the end devices 152 serving as SEDs may wake on occasion to poll for messages from a corresponding router 154. An interval between polling for an end device 152 may be based on a schedule or other configuration of a corresponding transceiver (e.g., the transceiver 216 of FIG. 2), and may be controlled by a processor, such as the host processor 213 of FIG. 2, the mesh network processing circuitry 234 of FIG. 2, and/or a power management unit (PMU) of the end device 152.

Examples of end devices 152 and/or routers 154 include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a vehicle, an electric meter, a gas pump, a kitchen appliance, a healthcare device, an implant, a sensor, an actuator, a display, or any other similar functioning device. Some of the end devices 152 and/or routers 154 may be referred to as Internet-of-Things (IoT) devices.

The mesh network 150 also includes a router 156 that serves as a leader node in the mesh network 150. In one or more implementations, the router 156 as the leader node can manage the overall network structure and operation of the mesh network 150, including initialization, synchronization, and topological control. The router 156 may act as a parent device for an end device 152 serving as a SED, buffering incoming data while the SED is in a sleep state. This procedure involves a downlink message to the SED, where the router 156 buffers the data until the SED awakens and queries for the data, known as the polling procedure. The SED then keeps its receiver (e.g., receiver portion of the transceiver 216 of FIG. 2) active for a specified duration to receive the incoming data. In one or more other implementations, the mesh network 150 also includes a border router 158 that may forward information between the mesh network 150 and a non-mesh network, such as the network 106, through the access point 140. The border router 158 can convert a Wi-Fi message to the mesh network communication protocol and transmit the converted mesh network message to a target end device (e.g., end device 152) using a mesh network radio.

Challenges arise when integrating with electronic devices such as smartphones, where radio resources are shared among various wireless technologies such as Wi-Fi and Bluetooth, posing coexistence constraints that can lead to interference with Bluetooth and Wi-Fi activities. According to the IEEE 802.15.4 specification, the maximum frame size may be 127 bytes, which corresponds to a transmission duration of approximately 5 ms. In one or more implementations, when a coexistence-constrained device (e.g., any one of end devices 152, routers 154, router 156, border router 158) communicates with a non-coexistence-constrained device (e.g., routers 154, router 156, border router 158), handling 127 bytes becomes challenging, particularly in scenarios where a continuous 5-ms slot is unavailable. The coexistence-constrained device may interoperate with other wireless communication protocols, such as Bluetooth operating on the 2.4 GHz frequency band. In scenarios where the transmission time is limited to, for example, 3 ms, accommodating 127 bytes becomes challenging. Therefore, a shorter frame size may be employed, which can be easier to manage on the transmission side. The coexistence-constrained device, acting as the transmitter, can independently decide to limit its transmission frame size. However, as a receiver, the coexistence-constrained device may not control the frame size transmitted by the non-coexistence-constrained device.

The subject technology addresses this challenge with dynamic frame size adaptation, which optimizes data reception by applying one or more techniques (e.g., an acknowledgment message indicating a frame size adaptation, a data frame information element indicating a frame size adaptation, a data poll message indicating a frame size adaptation, a medium access control (MAC) command indicating a frame size adaptation, an mesh link establishment (MLE) advertisement indicating a frame size adaptation, a type-length-value (TLV) encoding indicating a frame size adaptation, and/or a fragmentation header indicating a frame size adaptation), improving coexistence and reducing the power consumption of the end device 152. These approaches can enhance mesh network communication technologies, offering improved performance and efficiency in coexistence-constrained environments.

In one or more implementations, any combination of the described approaches can be used for frame size negotiation. Devices can be preconfigured to utilize one of these approaches or multiple approaches, depending on implementation without departing from the scope of the present disclosure. If one approach is unsuccessful, a device (e.g., the coexistence-constrained device 210) can transition to the next approach to ensure the frame size negotiation process is satisfied. This flexibility allows for dynamic adaptation to varying network conditions and requirements, optimizing communication efficiency and reliability in IEEE 802.15.4 networks.

FIG. 2 conceptually illustrates an example of a system 200 for performing signaling between a coexistence-constrained device and a non-coexistence-constrained device in a mesh network in accordance with one or more implementations. The system 200 may be a portion of the network environment 100. The coexistence-constrained device 210 may be, for example, one of the electronic devices 110 of the network environment 100. The non-coexistence-constrained device 210 may be, for example, one of the electronic devices 110 of the network environment 100.

The coexistence-constrained device 210 may include a host processor 213. The host processor 213 may execute instructions such that various operations of the coexistence-constrained device 210 are performed. For example, the host processor 213 can serve as the CPU responsible for executing instructions and managing various tasks. The host processor 213 can include multiple cores, each capable of handling multiple threads simultaneously, enabling multitasking. The host processor 213 can integrate various components such as arithmetic logic units (ALUs), registers, cache memory, and control units to execute instructions and process data. Additionally, the host processor 213 can include integrated DSPs, graphics processing units (GPUs), neural processing units (NPUs), and hardware accelerators for enhanced performance in tasks such as multimedia processing, artificial intelligence (AI), and gaming. The host processor 213 may be implemented using, for example, an ASIC, a controller, a FPGA device, another hardware device, a firmware device, or any combination thereof configured to perform the operations described herein.

The coexistence-constrained device 210 may include one or more transceiver(s) 216 that may include radio frequency (RF) transmitter and/or receiver circuitry that use the antenna(s) 232 of the coexistence-constrained device 210 to facilitate signaling (e.g., the signaling 250) to and/or from the coexistence-constrained device 210 with other devices (e.g., the non-coexistence-constrained device 210) according to corresponding wireless communication protocols (e.g., cellular, Wi-Fi, Bluetooth). The one or more transceivers 216 can be responsible for both transmitting and receiving radio signals. The one or more transceivers 216 can facilitate wireless communication by converting digital data into radio waves for transmission and then converting received radio waves back into digital data for the coexistence-constrained device 210 to process. The one or more transceivers 216 can operate within specific frequency bands allocated for wireless communication and may employ various modulation techniques to optimize data transmission efficiency and reliability. In one or more implementations, the one or more transceiver(s) 216 are not limited to specific wireless communication protocols, including Bluetooth, Thread®, Wi-Fi, cellular, among others, as it is appreciated that other wireless communication protocols and/or technologies can be associated with the one or more transceiver(s) 216.

The coexistence-constrained device 210 may include a memory 214. The memory 214 may be a non-transitory computer-readable storage medium that stores instructions 215 (which may include, for example, the instructions being executed by one or more components in the transceiver 216 and/or the host processor 213). The instructions 215 may also be referred to as program code or a computer program. The memory 224 may also store data used by, and results computed by, the transceiver 216 and/or the host processor 213.

The coexistence-constrained device 210 may include cellular processing circuitry 212. The cellular processing circuitry 212 is responsible for handling communication tasks related to the transmission and reception of wireless signals. The cellular processing circuitry 212 is specialized for managing the modulation, demodulation, encoding, decoding, and other signal processing tasks necessary for cellular communication. The cellular processing circuitry 212 can interface with the radio frequency (RF) components and antenna(s) (e.g., the one or more antennas 232) to transmit and receive data, voice, and other multimedia content over wireless networks such as Global System for Mobile Communications (GSM), CDMA, LTE, and 5G. The cellular processing circuitry 212 also manages power control, signal quality monitoring, and handover procedures to ensure reliable and efficient communication. The cellular processing circuitry 212 may execute instructions such that various operations of the coexistence-constrained device 210 are performed, as described herein. The cellular processing circuitry 212 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

In one or more implementations, the one or more transceivers 216 can operate in conjunction with the cellular processing circuitry 212 to facilitate cellular communication. The one or more transceivers 216 is responsible for converting digital data from the cellular processing circuitry 212 into radio signals for transmission over the air and for receiving incoming radio signals, which are then converted back into digital data for processing by the cellular processing circuitry 212. This collaboration enables the coexistence-constrained device 210 to transmit and receive data, supporting functions such as voice calls, text messaging, internet access, and other wireless services. The cellular processing circuitry 212 manages the digital signal processing tasks, while the one or more transceivers 216 handle the analog RF operations, working together to enable wireless communication capabilities in the coexistence-constrained device 210.

The coexistence-constrained device 210 may include Bluetooth processing circuitry 211. The Bluetooth processing circuitry 211 is responsible for managing the transmission and reception of wireless signals to and from mobile devices (e.g., coexistence-constrained device 210) for Bluetooth communication. The Bluetooth processing circuitry 211 can perform various signal processing tasks related to modulation, demodulation, encoding, decoding, and error correction to ensure reliable communication over the air interface. The Bluetooth processing circuitry 211 may execute instructions such that various operations of the coexistence-constrained device 210 are performed, as described herein. The Bluetooth processing circuitry 211 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the Bluetooth processing circuitry 211 to facilitate Bluetooth communication. The one or more transceivers 216 is responsible for converting digital data from the Bluetooth processing circuitry 211 into radio signals for transmission over the air and for receiving incoming radio signals, which are then converted back into digital data for processing by the Bluetooth processing circuitry 211. This collaboration enables the coexistence-constrained device 210 to transmit and receive data, supporting functions such as audio services, Internet access, and other wireless services via Bluetooth. The Bluetooth processing circuitry 211 manages the digital signal processing tasks, while the one or more transceivers 216 handle the analog RF operations, working together to enable wireless communication capabilities in the coexistence-constrained device 210.

The coexistence-constrained device 210 may include WLAN processing circuitry 219. The WLAN processing circuitry 219 is responsible for managing the transmission and reception of wireless signals to and from mobile devices (e.g., coexistence-constrained device 210) for Wi-Fi communication. The WLAN processing circuitry 219 can perform various signal processing tasks related to modulation, demodulation, encoding, decoding, and error correction to ensure reliable communication over the air interface. The WLAN processing circuitry 219 may execute instructions such that various operations of the coexistence-constrained device 210 are performed, as described herein. The WLAN processing circuitry 219 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the WLAN processing circuitry 219 to facilitate Wi-Fi communication. The one or more transceivers 216 is responsible for converting digital data from the WLAN processing circuitry 219 into radio signals for transmission over the air and for receiving incoming radio signals, which are then converted back into digital data for processing by the WLAN processing circuitry 219. This collaboration enables the coexistence-constrained device 210 to transmit and receive data, supporting functions such as voice calls, text messaging, Internet access, and other wireless services via Wi-Fi. The WLAN processing circuitry 219 manages the digital signal processing tasks, while the one or more transceivers 216 handle the analog RF operations, working together to enable wireless communication capabilities in the coexistence-constrained device 210.

The coexistence-constrained device 210 may include mesh network processing circuitry 234. The mesh network processing circuitry 234 is responsible for managing the transmission and reception of wireless signals to and from mobile devices (e.g., coexistence-constrained device 210) for mesh network communication. The mesh network processing circuitry 234 can perform various signal processing tasks related to modulation, demodulation, encoding, decoding, and error correction to ensure reliable communication over the air interface. The mesh network processing circuitry 234 may execute instructions such that various operations of the coexistence-constrained device 210 are performed, as described herein. The mesh network processing circuitry 234 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the mesh network processing circuitry 234 to facilitate mesh network communication. The one or more transceivers 216 is responsible for converting digital data from the mesh network processing circuitry 234 into radio signals for transmission over the air and for receiving incoming radio signals, which are then converted back into digital data for processing by the mesh network processing circuitry 234. This collaboration enables the coexistence-constrained device 210 to transmit and receive data, supporting functions such as voice calls, text messaging, Internet access, and other wireless services via the mesh network 150 of FIG. 1. The mesh network processing circuitry 234 manages the digital signal processing tasks, while the one or more transceivers 216 handle the analog RF operations, working together to enable wireless communication capabilities in the coexistence-constrained device 210.

The coexistence-constrained device 210 may include one or more antenna(s) 232 (e.g., one, two, four, or more). In implementations having multiple antenna(s) 230, the non-coexistence-constrained device 210 may perform multiple-in-multiple-out (MIMO), digital beamforming, analog beamforming, beam steering, etc. For implementations with multiple antenna(s) 232, the coexistence-constrained device 210 may leverage the spatial diversity of such multiple antenna(s) 232 to send and/or receive multiple different data streams on the same time and frequency resources.

The coexistence-constrained device 210 may include one or more interface(s) 217. The interface(s) 217 may be used to provide input to or output from the coexistence-constrained device 210. For example, a coexistence-constrained device 210 that is a UE may include interface(s) 217 such as microphones, speakers, a touchscreen, buttons, and the like to allow for input and/or output to the UE by a user of the UE. Other interfaces of such a UE may be made up of made up of transmitters, receivers, and other circuitry (e.g., other than the transceiver(s) 216/antenna(s) 232 already described) that allow for communication between the UE and other devices and may operate according to known protocols (e.g., Wi-Fi®, Bluetooth®, and the like).

The coexistence-constrained device 210 may include frame size negotiation module 218. The frame size negotiation module 218 may be implemented via hardware, software, or combinations thereof. For example, the frame size negotiation module 218 may be implemented as a processor, circuit, and/or instructions 215 stored in the memory 214 and executed by the host processor 213 and/or the transceiver 216. In some examples, the frame size negotiation module 218 may be integrated within the transceiver(s) 216. For example, the frame size negotiation module 218 may be implemented by a combination of software components (e.g., executed by a DSP or a general processor) and hardware components (e.g., logic gates and circuitry) within the transceiver(s) 216. In other examples, the frame size negotiation module 218 is a separate component from the transceiver(s) 216.

The coexistence-constrained device 210 may include coexistence module 238. The coexistence module 238 may be implemented via hardware, software, or combinations thereof. For example, the coexistence module 238 may be implemented as a processor, circuit, and/or instructions 215 stored in the memory 214 and executed by the host processor 213 and/or the transceiver 216. In some examples, the coexistence module 238 may be integrated within the transceiver(s) 216. For example, the coexistence module 238 may be implemented by a combination of software components (e.g., executed by a DSP or a general processor) and hardware components (e.g., logic gates and circuitry) within the transceiver(s) 216. In other examples, the coexistence module 238 is a separate component from the transceiver(s) 216.

The frame size negotiation module 218 may be used for various aspects of the present disclosure, for example, aspects of FIG. 1 through FIG. 10. The frame size negotiation module 218 is configured to, for example, apply a dynamic frame size adaptation to a resource allocation associated with a first wireless communication protocol (e.g., mesh network). The frame size negotiation module 218 is also configured to, for example, provide for transmission, to the non-coexistence-constrained device 210, an indication of the dynamic frame size adaptation. The frame size negotiation module 218 is also configured to, for example, using the mesh network processing circuitry 234, monitor for reception of a data transmission associated with the first wireless communication protocol on a shared frequency band (e.g., 2.4 GHz) based at least in part on the dynamic frame size adaptation.

The non-coexistence-constrained device 210 may include a host processor 223. The host processor 223 may execute instructions such that various operations of the non-coexistence-constrained device 210 are performed. For example, the host processor 223 can serve as the central processing unit (CPU) responsible for executing instructions and managing various tasks. The host processor 223 can include multiple cores, each capable of handling multiple threads simultaneously, enabling multitasking. The host processor 223 can integrate various components such as ALUs, registers, cache memory, and control units to execute instructions and process data. Additionally, the host processor 223 can include integrated DSPs, GPUs, NPUs, and hardware accelerators. The host processor 223 may be implemented using, for example, an ASIC, a controller, a FPGA device, another hardware device, a firmware device, or any combination thereof configured to perform the operations described herein.

The non-coexistence-constrained device 210 may include one or more transceiver(s) 226 that may include RF transmitter and/or receiver circuitry that use the antenna(s) 230 of the non-coexistence-constrained device 210 to facilitate signaling (e.g., the signaling 250) to and/or from the non-coexistence-constrained device 210 with other devices (e.g., the coexistence-constrained device 210) according to corresponding wireless communication protocols (e.g., cellular, Wi-Fi, Bluetooth). The one or more transceivers 226 can be responsible for both transmitting and receiving radio signals. The one or more transceivers 226 can facilitate wireless communication by converting digital data into radio waves for transmission and then converting received radio waves back into digital data for the non-coexistence-constrained device 210 to process. The one or more transceivers 226 can operate within specific frequency bands allocated for wireless communication and may employ various modulation techniques to optimize data transmission efficiency and reliability. In one or more implementations, the one or more transceiver(s) 226 are not limited to specific wireless communication protocols, including Bluetooth, Thread®, Wi-Fi, cellular, among others, as it is appreciated that other wireless communication protocols and/or technologies can be associated with the one or more transceiver(s) 226.

The non-coexistence-constrained device 210 may include a memory 224. The memory 224 may be a non-transitory computer-readable storage medium that stores instructions 225 (which may include, for example, the instructions being executed by one or more components in the transceiver 226 and/or the host processor 223). The instructions 225 may also be referred to as program code or a computer program. The memory 224 may also store data used by, and results computed by, the transceiver 226 and/or the host processor 223.

The non-coexistence-constrained device 210 may include mesh network processing circuitry 236. The mesh network processing circuitry 236 is responsible for managing the transmission and reception of wireless signals to and from mobile devices (e.g., coexistence-constrained device 210) for mesh network communication. The mesh network processing circuitry 236 can perform various signal processing tasks related to modulation, demodulation, encoding, decoding, and error correction to ensure reliable communication over the air interface. The mesh network processing circuitry 236 may execute instructions such that various operations of the non-coexistence-constrained device 210 are performed, as described herein. The mesh network processing circuitry 236 may include one or more processors implemented using, for example, a CPU, a DSP, an ASIC, a controller, an FPGA device, another hardware device, a firmware device, or any combination thereof configured to perform the operations described herein.

In one or more implementations, the one or more transceivers 226 can operate in conjunction with the mesh network processing circuitry 236 to facilitate mesh network communication. The one or more transceivers 226 is responsible for converting digital data from the mesh network processing circuitry 236 into radio signals for transmission over the air and for receiving incoming radio signals, which are then converted back into digital data for processing by the mesh network processing circuitry 236. This collaboration enables the non-coexistence-constrained device 210 to transmit and receive data, supporting functions such as audio services, Internet access, and other wireless services via the mesh network 150 of FIG. 1. The mesh network processing circuitry 236 manages the digital signal processing tasks, while the one or more transceivers 226 handle the analog RF operations, working together to enable wireless communication capabilities in the non-coexistence-constrained device 210.

The non-coexistence-constrained device 210 may include one or more antenna(s) 230 (e.g., one, two, four, or more). In implementations having multiple antenna(s) 230, the non-coexistence-constrained device 210 may perform multiple-in-multiple-out (MIMO), digital beamforming, analog beamforming, beam steering, etc.

The non-coexistence-constrained device 210 may include one or more interface(s) 227. The interface(s) 227 may be used to provide input to or output from the non-coexistence-constrained device 210. For example, a non-coexistence-constrained device 210 may include interface(s) 227 made up of transmitters, receivers, and other circuitry (e.g., other than the transceiver(s) 226/antenna(s) 230 already described) that enables the non-coexistence-constrained device 210 to communicate with other equipment in the mesh network 150, and/or that enables the non-coexistence-constrained device 210 to communicate with external networks, computers, databases, and the like for purposes of operations, administration, and maintenance of the non-coexistence-constrained device 210 or other equipment operably connected thereto.

The non-coexistence-constrained device 210 may include a frame size negotiation module 228. The frame size negotiation module 228 may be implemented via hardware, software, or combinations thereof. For example, the frame size negotiation module 228 may be implemented as a processor, circuit, and/or instructions 225 stored in the memory 224 and executed by one or more components in the transceiver 226. In some examples, the frame size negotiation module 228 may be integrated within the transceiver(s) 226. For example, the frame size negotiation module 228 may be implemented by a combination of software components (e.g., executed by a DSP or a general processor) and hardware components (e.g., logic gates and circuitry) within the transceiver(s) 226. In other examples, the frame size negotiation module 228 is a separate component from the transceiver(s) 226.

In one or more implementations, multiple wireless communication protocols (e.g., mesh network and Bluetooth technologies) may coexist in an electronic device (e.g., electronic devices 110-112 of FIG. 1) with a shared radio that operates at 2.4 gigahertz for both Bluetooth and mesh network technologies. The integrated circuit (IC) chip responsible for modulation and demodulation, the software stack, the hardware stack, and the antennas for transmission and reception may all be shared resources between the Bluetooth and mesh network technologies. In one or more implementations, when the mesh network processing circuitry 234 is active, the Bluetooth processing circuitry 211 may not be active, and vice versa, resulting in time division multiplexing between the Bluetooth and mesh network technologies.

In one or more implementations, various techniques can be employed to enable coexistence between different wireless communication protocols without compromising quality of data. For example, an electronic device can support multiple Bluetooth audio profiles, including a music streaming service profile, a casting service profile, a video call service profile, and a cellular call service profile, without degradation in quality. For example, a user of the electronic device may be engaged in an LTE video call with audio over Bluetooth headsets while controlling home accessories with the same electronic device. These home accessories can include unlocking a door, granting access, turning on a light bulb, and/or opening a garage door, all while utilizing a shared radio with coexistence constraints. In one or more other implementations, the same radio resources between the mesh network processing circuitry 234 and the Bluetooth processing circuitry 211 may be shared without degrading the quality of the Bluetooth audio profiles.

In one or more implementations, the coexistence-constrained device 210 functioning as a transmitter can independently adapt a frame size. However, the coexistence-constrained device 210 acting as a receiver may not control the frame size of the transmitter on the other end without employing a negotiation scheme. This lack of control can affect the receiver's ability to manage frame sizes efficiently during data transmission. In one or more implementations, the maximum frame size may be fixed at 127 bytes. This frame size translates to approximately 5 milliseconds (ms) of air-time utilization by both a transmitter and a receiver. This duration may account for the time required for the complete transmission and reception of a frame within defined parameters of the IEEE 802.15.4 standard.

In one or more implementations, the operation of electronic devices in the 2.4 GHZ frequency band, for example, can result in shared radio resources between different wireless communication protocols (e.g., mesh network, Bluetooth, Wi-Fi), which operate in the same overlapping frequencies. This overlap necessitates efficient management of radio resources to minimize interference and ensure reliable communication among these technologies. In one or more implementations, in coexistence-challenged scenarios, the coexistence-constrained device 210 may not obtain a contiguous duration (e.g., 5 ms) of exclusive access to radio resources necessary to complete the transmission or reception of a 127-byte frame. This limitation can lead to the corruption of data packets associated with different wireless communication protocols (e.g., mesh network, Bluetooth, Wi-Fi) due to overlapping use of the same radio frequencies.

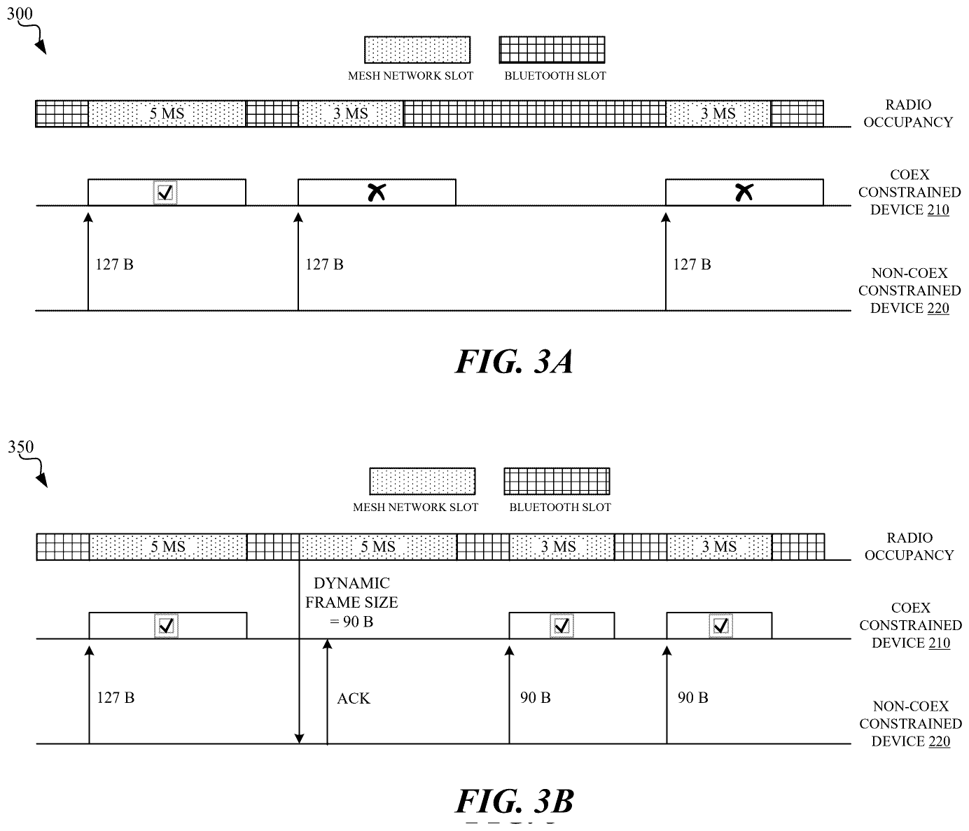

Embodiments of the subject technology provide for dynamic frame size adaptation. An apparatus may apply a frame size adaptation to a resource allocation associated with a first wireless communication protocol based on a coexistence between activity associated with the first wireless communication protocol and activity associated with a second wireless communication protocol different than the first wireless communication protocol on a shared frequency band. The apparatus also may monitor for reception of a data transmission associated with the first wireless communication protocol on the shared frequency band based at least in part on the frame size adaptation. By dynamically adapting the frame size, the reliability of transmissions in a mesh network is increased and coexistence between radios sharing the same frequency band can be improved. Examples of this dynamic frame size adaptation will be described with reference to FIGS. 3-10.

FIG. 3A is a schematic diagram illustrating an example frame exchange 300 between a coexistence-constrained device 210 and a non-coexistence-constrained device 220 in accordance with one or more implementations. According to the IEEE 802.15.4 specification, the maximum frame size may be 127 bytes, which corresponds to a transmission duration of approximately 5 ms. In one or more implementations, when a coexistence-constrained device (e.g., any one of end devices 152, routers 154, router 156, border router 158) communicates with a non-coexistence-constrained device (e.g., routers 154, router 156, border router 158), handling 127 bytes becomes challenging, particularly in scenarios where a continuous 5-ms slot is unavailable. The coexistence-constrained device may interoperate with other wireless communication protocols, such as Bluetooth operating on the 2.4 GHz frequency band. In scenarios where the transmission time is limited to, for example, 3 ms, accommodating 127 bytes becomes challenging. For example, as illustrated in FIG. 3A, the data transmission from the non-coexistence constrained device 220 to the coexistence-constrained device 210 may not be successful. Therefore, a shorter frame size may be employed, which can be easier to manage on the transmission side. The coexistence-constrained device, acting as the transmitter, can independently decide to limit its transmission frame size. However, as a receiver, the coexistence-constrained device may not control the frame size transmitted by the non-coexistence-constrained device.

FIG. 3B is a schematic diagram illustrating an example frame exchange 350 with dynamic frame size adaptation between a coexistence-constrained device 210 and a non-coexistence-constrained device 220 in accordance with one or more implementations. In one or more implementations, approaches to negotiation between the coexistence-constrained device 210 and the non-coexistence-constrained device 220 to agree upon frame sizes are described herein. This negotiation between the coexistence-constrained device 210 and the non-coexistence-constrained device 220 may involve determining the best-case transmission time available. In this scenario, the maximum frame size that the coexistence-constrained device 210 can support is negotiated in advance. For example, the coexistence conditions in the scenario depicted in FIGS. 3A and 3B may limit the transmission time to about 3 ms, thus limiting the maximum frame size that the coexistence-constrained device 210 can support to about 90 bytes. As such, the coexistence-constrained device 210 may send an indication indicating a frame size adjustment to 90 bytes based on the coexistence conditions on the communication medium. The non-coexistence constrained device 220 receives the indication and, in response, sends an acknowledgment frame back to the coexistence-constrained device 210 to acknowledge the frame size adjustment. Subsequently, the non-coexistence-constrained device 220 adheres to this maximum frame size. In this regard, for example, transmissions of 90-byte frames from the non-coexistence constrained device 220 to the coexistence-constrained device 210 can be received successfully at the coexistence-constrained device 210.

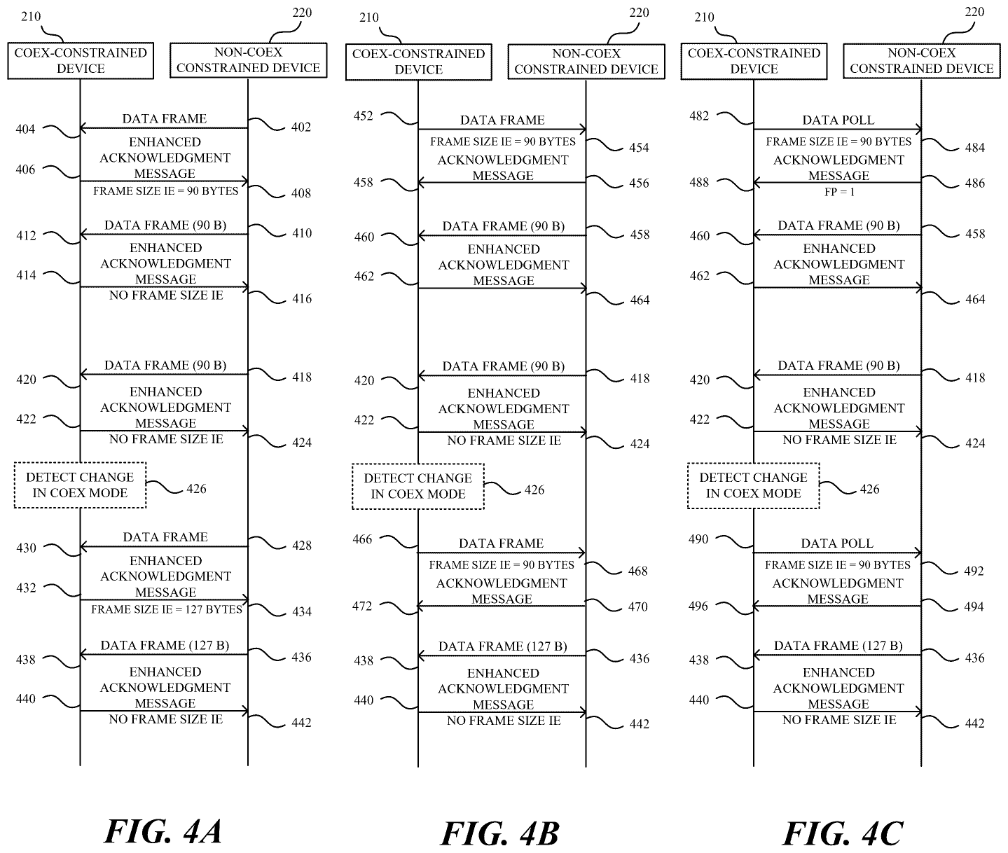

In one or more implementations, the non-coexistence-constrained device 220 may be an accessory from a different vendor and may not be a product that can be directly controlled. This necessitates the implementation of a negotiation framework to avoid directly limiting the frame size to 90 bytes. Additionally, within the mesh network 150, these devices can have different roles. The coexistence-constrained device 210 may function as a sleepy end device (e.g., end device 152), a sleepy router (e.g., router 154), a router (e.g., router 154), or a leader node (e.g., router 156). Depending on these roles and the roles of peer devices, various negotiation schemes can be employed as will be discussed with reference to FIGS. 4A-4C, 5-10.

The dynamic frame size adaptation as described with reference to FIG. 3B optimize data reception by applying different techniques (e.g., an acknowledgment message indicating a frame size adaptation, a data frame information element indicating a frame size adaptation, a data poll message indicating a frame size adaptation, a MAC command indicating a frame size adaptation, an MLE advertisement indicating a frame size adaptation, a TLV encoding indicating a frame size adaptation, and/or a fragmentation header indicating a frame size adaptation), improving coexistence and reducing the power consumption of the coexistence-constrained device 210. This approach enhances mesh network communication technologies, offering improved performance and efficiency in coexistence-constrained environments.

In one or more implementations, the aforementioned negotiation schemes may be less reliant on real-time coexistence conditions. Some of these approaches, involving broadcasting or using unicast messages to individual nodes, operate with varying degrees of responsiveness. For example, unicast messages may allow for more immediate adjustments in frame size, reacting faster to changing network conditions compared to broadcast messages. In one or more other implementations, scaling can become challenging when roles are switched or when multiple devices are involved, such as in scenarios where the coexistence-constrained device 210 operating as a sleepy router or router interacts with numerous end devices (assuming roles as child devices) or neighboring routers. In one or more other implementations, relying solely on enhanced acknowledgment messages may facilitate the use of multiple strategies to ensure effective frame size negotiation and management across complex network topologies.

FIGS. 4A-4C are schematic diagrams of different examples of dynamic frame size adaptation between a coexistence-constrained device and a non-coexistence-constrained device in accordance with one or more implementations. In one or more implementations, an approach involves indicating the maximum frame size that the coexistence-constrained device 210 can support as part of an enhanced acknowledgment to the non-coexistence constrained device 220. In one or more implementations, the coexistence-constrained device 210 may be implemented as a SED or SSED while the non-coexistence constrained device 220 may assume the role of a parent device and may be implemented as a router (e.g., router 154) or a leader node (e.g., router 156).

As illustrated in FIG. 4A, at 402, a non-coexistence constrained device 220 may send a data frame to the coexistence-constrained device 210. At 404, the coexistence-constrained device 210 may receive the data frame from the non-coexistence constrained device 220. At 406, the coexistence-constrained device 210 may transmit an enhanced acknowledgment message acknowledging receipt of the data frame transmitted at 402. The enhanced acknowledgment message can be used to facilitate frame size adaptation requests. For example, the enhanced acknowledgment message may include a frame size IE indicating a frame size adjustment request to 90 bytes. At 408, the non-coexistence constrained device 220 receives the acknowledgment frame from the coexistence-constrained device 210. At 412, the coexistence-constrained device 210 receives a 90-byte data frame transmitted from the non-coexistence constrained device 220 at 410. At 414, the coexistence-constrained device 210 sends an enhanced acknowledgment message to acknowledge receipt of the data frame transmitted from the non-coexistence constrained device 220 at 410. At 416, the non-coexistence constrained device 220 receives the acknowledgment frame from the coexistence-constrained device 210.

At 420, the coexistence-constrained device 210 receives a 90-byte data frame transmitted from the non-coexistence constrained device 220 at 418. At 422, the coexistence-constrained device 210 sends an enhanced acknowledgment message to acknowledge receipt of the data frame transmitted from the non-coexistence constrained device 220 at 418. At 424, the non-coexistence constrained device 220 receives the acknowledgment frame from the coexistence-constrained device 210.

In this scenario, the non-coexistence constrained device 220 assuming the role as parent sends a data frame, and ahead of the coexistence mode change at 426, an enhanced acknowledgment includes a vendor-specific information element (IE) indicating the maximum frame size. This allows the non-coexistence constrained device 220 to limit the frame size accordingly. Once the coexistence limitation is resolved, the non-coexistence constrained device 220 can indicate that the frame size can be switched back to the frame size maximum of 127 bytes. The SED or SSED can indicate the new frame size in the enhanced acknowledgment. For example, at 432, the coexistence-constrained device 210 sends an enhanced acknowledgment message including a frame size IE indicating the frame size adjustment to 127 bytes. At 434, the non-coexistence constrained device 220 receives the acknowledgment frame from the coexistence-constrained device 210. In one or more implementations, if the coexistence-constrained device 210 initially requests a 90-byte frame size due to limited time slots for receiving full frames, the coexistence-constrained device 210 may continue to do so. The enhanced acknowledgment message from the coexistence-constrained device 210 may confirm whether it received the frame or indicate that it did not. This negotiation between the coexistence-constrained device 210 and the non-coexistence constrained device 220 aims to preemptively adjust frame sizes before entering a coexistence mode that may restrict the ability to handle 127-byte frames.

In one or more implementations, the coexistence-constrained device 210 may continuously monitor for a change in coexistence mode. When a coexistence mode change occurs, the coexistence-constrained device 210 can trigger the generation and transmission of an enhanced acknowledgment message, which includes a new frame size request. This process may utilize a module that monitors activity levels on the network (e.g., the coexistence module 238) and may utilize a module that adjusts its frame size setting dynamically based on the maximum slot duration feasible (e.g., frame size negotiation module 218). This adjustment allows the device to adapt its frame size dynamically, facilitating efficient communication despite varying network conditions. For example, at 426, the coexistence-constrained device 210 detects a change in coexistence mode. At 430, the coexistence-constrained device 210 receives a data frame transmitted from the non-coexistence constrained device 220 at 428. In turn, based on the detected change in coexistence mode, the coexistence-constrained device 210, at 432, sends an enhanced acknowledgment message with a frame size IE indicating a frame size adjustment request to 127 bytes. At 438, the coexistence-constrained device 210 receives a 127-byte data frame transmitted from the non-coexistence constrained device 220 at 436. At 440, the coexistence-constrained device 210 sends an enhanced acknowledgment message to acknowledge receipt of the data frame transmitted from the non-coexistence constrained device 220 at 436. At 442, the non-coexistence constrained device 220 receives the acknowledgment frame from the coexistence-constrained device 210.

In one or more other implementations, another approach involves indicating the maximum frame size that the coexistence-constrained device 210 can support as a data frame to the non-coexistence constrained device 220. For brevity of explanation, only the differences between FIG. 4A and FIG. 4B will be discussed with reference to FIG. 4B. As illustrated in FIG. 4B, at 450, the coexistence-constrained device 210 may send a data frame to the non-coexistence constrained device 220. The data frame may include a frame size IE indicating a frame size adjustment to 90 bytes, for example. At 452, the non-coexistence constrained device 220 may receive the data frame from the coexistence-constrained device 210.

At 454, the non-coexistence constrained device 220 may transmit an acknowledgment message acknowledging receipt of the data frame transmitted at 450. At 456, the coexistence-constrained device 210 receives the acknowledgment frame from the non-coexistence constrained device 220. At 458, the non-coexistence constrained device 220 transmits a 90-byte data frame the coexistence-constrained device 210. At 460, the coexistence-constrained device 210 receives the 90-byte data frame transmitted at 458. At 462, the coexistence-constrained device 210 sends an enhanced acknowledgment message to acknowledge receipt of the data frame transmitted from the non-coexistence constrained device 220 at 458. At 464, the non-coexistence constrained device 220 receives the acknowledgment frame from the coexistence-constrained device 210.

The coexistence-constrained device 210 may detect a change in coexistence mode at 426 of FIG. 4B. Subsequently, based on the detected change in coexistence mode, at 466, the coexistence-constrained device 210 sends a data frame to the non-coexistence constrained device 220. The data frame may include with a frame size IE indicating a frame size adjustment request to 90 bytes. At 468, the non-coexistence constrained device 220 receives the data frame. At 470, the non-coexistence constrained device 220 sends an acknowledgment message to the coexistence-constrained device 210. At 472, the coexistence-constrained device 210 receives the acknowledgment message from the non-coexistence constrained device 220.

In one or more other implementations, another approach involves indicating the maximum frame size that the coexistence-constrained device 210 can support as a data poll message to the non-coexistence constrained device 220. For brevity of explanation, only the differences between FIG. 4B and FIG. 4C will be discussed with reference to FIG. 4C. As illustrated in FIG. 4C, at 482, the coexistence-constrained device 210 may send a data poll message to the non-coexistence constrained device 220. The data poll message may include a frame size information element indicating a frame size adjustment to 90 bytes, for example. At 484, the non-coexistence constrained device 220 may receive the data poll message from the coexistence-constrained device 210. During data polling, the coexistence-constrained device 210 can periodically enter a sleep state to conserve power and awaken to query its leader (or parent device) such as the non-coexistence constrained device 220 for data. If data is available, the non-coexistence constrained device 220 buffers the data until the coexistence-constrained device 210 retrieves it, necessitating the coexistence-constrained device 210 to activate its receiver for a specified duration. At 486, the non-coexistence constrained device 220 may transmit an acknowledgment message acknowledging receipt of the data poll message transmitted at 482. At 488, the coexistence-constrained device 210 receives the acknowledgment frame from the non-coexistence constrained device 220.

The coexistence-constrained device 210 may detect a change in coexistence mode at 426 of FIG. 4C. Subsequently, based on the detected change in coexistence mode, at 490, the coexistence-constrained device 210 sends a data poll message to the non-coexistence constrained device 220. The data poll message may include with a frame size IE indicating a frame size adjustment request to 90 bytes. At 492, the non-coexistence constrained device 220 receives the data poll message. At 494, the non-coexistence constrained device 220 sends an acknowledgment message to the coexistence-constrained device 210. At 496, the coexistence-constrained device 210 receives the acknowledgment message from the non-coexistence constrained device 220.

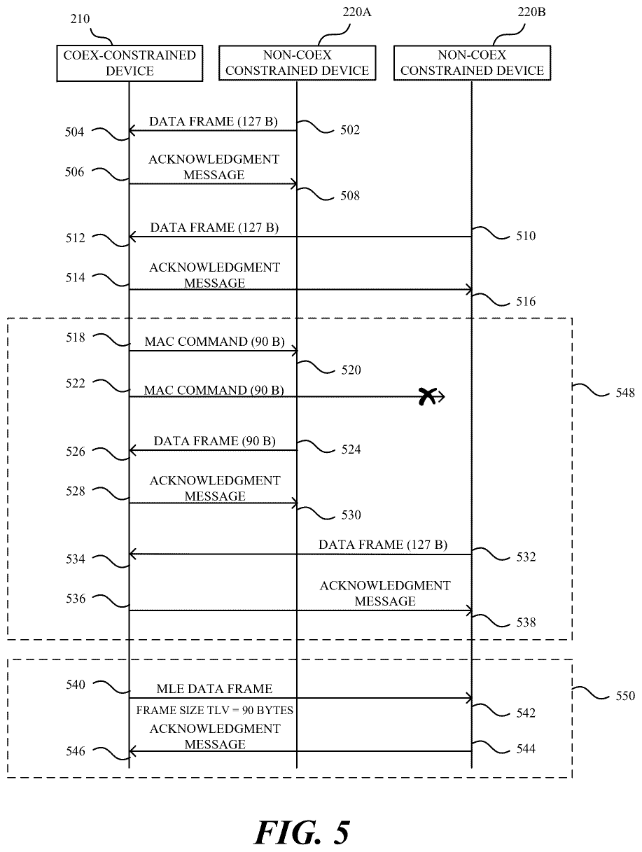

FIG. 5 is a schematic diagram illustrating an example dynamic frame size adaptation procedure between a coexistence-constrained device 210 and multiple non-coexistence-constrained devices (e.g., a first non-coexistence constrained device 220a, a second non-coexistence constrained device 220b) in accordance with one or more implementations.

At 502, the first non-coexistence constrained device 220a sends a 127-byte data frame to the coexistence-constrained device 210. At 504, the coexistence-constrained device 210 receives the data frame transmitted from the first non-coexistence constrained device 220a at 502. At 506, the coexistence-constrained device 210 sends an acknowledgment message acknowledging receipt of the data frame, to the first non-coexistence constrained device 220a. At 508, the first non-coexistence constrained device 220a receives the acknowledgment message from the coexistence-constrained device 210.

At 510, the second non-coexistence constrained device 220b sends a 127-byte data frame to the coexistence-constrained device 210. At 512, the coexistence-constrained device 210 receives the data frame transmitted from the second non-coexistence constrained device 220b at 510. At 514, the coexistence-constrained device 210 sends an acknowledgment message acknowledging receipt of the data frame, to the second non-coexistence constrained device 220b. At 516, the second non-coexistence constrained device 220b receives the acknowledgment message from the coexistence-constrained device 210.

In one or more implementations, another approach involves indicating the frame size adaptation in a MAC command. In IEEE 802.15.4 networks, a MAC command is a type of frame utilized for controlling network functions and maintaining proper communication among devices. This command facilitates various tasks, such as association and disassociation of devices, data request, beacon request, coordinator realignment, and orphan notification. Each MAC command frame may include a MAC header specifying the frame type and addressing information, followed by a payload containing command-specific parameters.

As illustrated in FIG. 5, a MAC command can be used instead of a MAC data frame to indicate the frame size adjustment. This approach may combine multiple approaches during a frame size negotiation window 548. At 518, the coexistence-constrained device 210 may broadcast a MAC command that specifies the frame size adjustment to 90 bytes. In one or more implementations, the MAC command may indicate the frame size adjustment using one or more reserved bits in a reserved command range. At 520, the first non-coexistence constrained device 220a receives the MAC command transmitted at 518. At 522, the coexistence-constrained device 210 also may broadcast the MAC command to the second non-coexistence constrained device 220b, which does not successfully reach the second non-coexistence constrained device 220b. In one or more other implementations, the coexistence-constrained device 210 may unicast the MAC commands individually to the first non-coexistence constrained device 220a and/or the second non-coexistence constrained device 220b. When the first non-coexistence constrained device 220a receives this MAC command broadcast, the non-coexistence constrained device 220a sends a 90-byte data frame at 524. At 526, the coexistence-constrained device 210 receives the 90-byte data frame from the first non-coexistence constrained device 220a. At 528, the coexistence-constrained device 210 acknowledges receipt of the 90-byte data frame by sending an acknowledgment message to the first non-coexistence constrained device 220a. At 530, the first non-coexistence constrained device 220a receives the acknowledgment message transmitted at 528. At 532, the second non-coexistence constrained device 220b sends a 127-byte data frame and received by the coexistence-constrained device 210 at 534. At 536, the coexistence-constrained device 210 sends an acknowledgment message to the second non-coexistence constrained device 220b in response to the 127-byte data frame, which is then received by the second non-coexistence constrained device 220b at 538.

In one or more other implementations, the second non-coexistence constrained device 220b continues to use the 127-byte frame size until it receives an MLE message during an MLE occurrence window 550. At 540, the MLE message is transmitted by the coexistence-constrained device 210 to the second non-coexistence constrained device 220b. At 542, the second non-coexistence constrained device 220b receives the MLE message. In turn, at 544, the second non-coexistence constrained device 220b sends an acknowledgment message to the coexistence-constrained device 210 and received by the coexistence-constrained device 210 at 546. In this MLE message, the TLV encoding indicates the frame size adaptation, prompting the second non-coexistence constrained device 220b to adjust the frame size setting to 90 bytes for outgoing data transmissions to the coexistence-constrained device 210.

The scenario depicted in FIG. 5 combines the approach of broadcasting a MAC command with unicasting MLE messages to reinforce the dynamic frame size adaptation. For example, the first message (e.g., MAC command at 518, 522) is a broadcast message sent to both devices (e.g., the first non-coexistence constrained device 220a and the second non-coexistence constrained device 220b). The first non-coexistence constrained device 220a receives the MAC command broadcast and adjusts its data frame size setting to 90 bytes for future data transmissions to the coexistence-constrained device 210. Meanwhile, the second non-coexistence constrained device 220b, which does not receive the MAC command broadcast, continues using the 127-byte frame size. Subsequently, when the second non-coexistence constrained device 220b receives a unicast MLE message at 542, the second non-coexistence constrained device 220b is informed to use a 90-byte frame size.

In one or more implementations, another approach involves indicating the frame size adaptation as a TLV encoding in a MLE advertisement. This approach may address the limitation of being restricted to routers or leaders, as routers periodically send out these MLE advertisements. By including an additional data length parameter that indicates the frame size, this information can be disseminated to all peer routers. In one or more implementations, MLE advertisements may be exchanged every 30 seconds. In one or more other implementations, these MLE advertisements can be sent as multicast messages without acknowledgments, making the reliability dependent on which devices receive the information.

In one or more other implementations, another approach involves indicating the maximum frame size information in all outgoing MLE messages, such as keep-alive messages and child supervision messages. This approach facilitates that the information is part of any MLE message or control message, enhancing reliability across all mesh network roles.

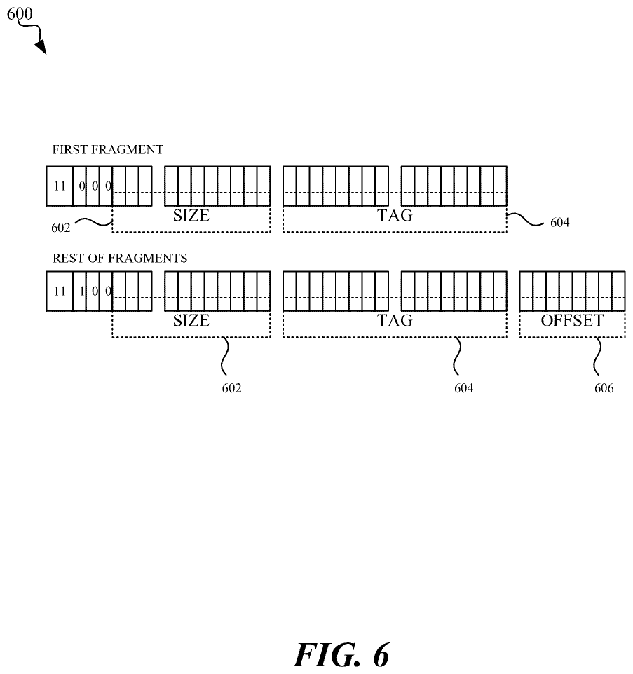

FIG. 6 is a schematic diagram illustrating an example fragmentation header 600 in accordance with one or more implementations. In one or more other implementations, another approach involves indicating the frame size adaptation by adding a fragmentation header to a MAC data frame. In IEEE 802.15.4 networks, a MAC data frame may be a fundamental structure used for the transmission of data between devices. The MAC data frame can include a MAC header, a payload, and a frame check sequence (FCS). The MAC header may contain addressing information, frame control details, and sequence numbers. The payload may carry the actual data intended for the recipient device. The FCS can be used for error detection to ensure data integrity during transmission. MAC data frames can facilitate reliable delivery of information in LR-WPANs, supporting various applications such as monitoring, control, and automation.

In one or more implementations, for IPV6 communication in IEEE 802.15.4-based networks, a 6LoWPAN layer may exist between the network layer and the data link layer (e.g., MAC layer) in the protocol stack. The 6LoWPAN layer can serve as an adaptation layer that enables IPv6 packets to be sent and received over IEEE 802.15.4-based networks. This layer may handle the compression, fragmentation, and reassembly of IPv6 packets to accommodate the limited frame size of IEEE 802.15.4 (e.g., 127 bytes). Although the 6LoWPAN layer may already handle fragmentation, the fragmentation header as described in FIG. 6 can be used for frames smaller than 127 bytes.

In one or more implementations, the fragmentation header 600 may incorporate fragment size information (e.g., fragment size 602). Each fragment within this structure can be tagged with a common tag (e.g., tag 604) and an offset (e.g., offset 606), indicating its position within the original frame. In one or more implementations, the tag 604 may be an unsigned integer that serves to identify fragments belonging to the same original packet. For example, if a packet is 1200 bytes and is fragmented into 127-byte fragments, it would result in approximately ten fragments. Each of these 10 fragments may contain a common tag (e.g., the tag 604) that links them to the original packet. Alongside the tag 604, the fragmentation header 600 can include additional pieces of information: the data frame length, which specifies the total size of the original packet (e.g., 1200 bytes in this case), and the offset 606. The offset 606 can indicate where each fragment starts within the original packet. For example, the first fragment may start at offset 0, the second fragment may start at an offset corresponding to 128 bytes, the third fragment may start at an offset corresponding to 256 bytes, and so forth, aligning with the fragment boundaries. In one or more implementations, these fragments may not need to arrive in order. In one or more other implementations, a predefined time limit (e.g., about 60 seconds) may be set for the arrival of the entire set of fragments.

In one or more implementations, the purpose of including the tag 604 and the offset 606 in transmitted frames is to provide a receiver (e.g., non-coexistence constrained device 220 or coexistence-constrained device 210) with information for packet reassembly. For example, when the coexistence-constrained device 210 transmits a fragmented frame smaller than 127 bytes, the coexistence-constrained device 210 may include a header that corresponds to, or includes at least in part, the fragmentation header 600. The fragmentation header 600 may signal to the receiver how to handle the fragmented data, facilitating that it can correctly reconstruct the original packet. Conversely, the information in the fragmentation header 600 also can guide the transmitter in fragmenting data efficiently based on prevailing network conditions. In one or more implementations, when transmitting data frames smaller than the maximum frame size of 127 bytes, the sender (e.g., the coexistence-constrained device 210) may omit, in its entirety or at least a portion of, the fragmentation header 600. For example, if a data packet has a frame size of 90 bytes and fits within a single frame, there may be no need to add, in its entirety or at least a portion of, the fragmentation header 600 under normal circumstances. In one or more other implementations, in coexistence constrained scenarios, even if the packet size is less than 127 bytes, the sender includes, in its entirety or at least a portion of, the fragmentation header 600. As illustrated in FIG. 6, the fragmentation header 600 includes the tag 604 and specifies a fragment size 602, indicating to the receiver how to handle the fragmented data during transmission back to the sender. This fragmentation header 600 can facilitate that the receiver adjusts its transmission behavior accordingly, maintaining effective communication in environments where coexistence constraints may affect network performance.

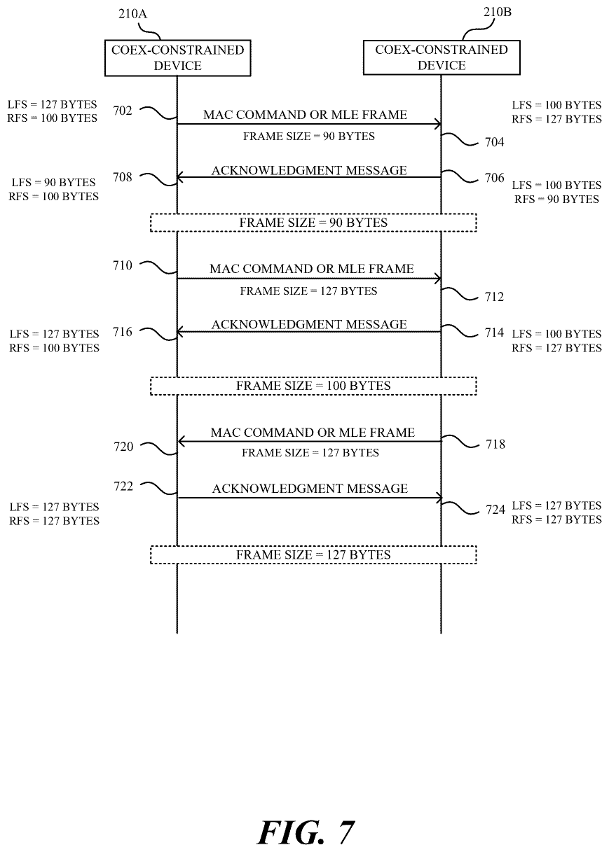

FIG. 7 is a schematic diagram illustrating an example dynamic frame size adaptation procedure between multiple coexistence-constrained devices (e.g., coexistence-constrained device 210a and coexistence-constrained device 210b) in accordance with one or more implementations. In one or more implementations, frame sizes may be negotiated between two coexistence-constrained devices (e.g., coexistence-constrained device 210a and coexistence-constrained device 210b). As illustrated in FIG. 7, the coexistence-constrained device 210a may handle a maximum frame size of 127 bytes while the coexistence-constrained device 210b may have frame size limitations and may handle a maximum frame size of 100 bytes. In one or more other implementations, in scenarios where both the coexistence-constrained device 210a and the coexistence-constrained device 210b have frame size limitations, a bidirectional negotiation process can be established between the coexistence-constrained device 210a and the coexistence-constrained device 210b. This negotiation aims to determine the smallest possible frame size that both devices can support. For example, if one coexistence-constrained device can manage 100 bytes and the other coexistence-constrained device can only handle 90 bytes, the two coexistence-constrained devices negotiate and agree upon using a 90-byte frame size. If circumstances change, such as a shift in coexistence conditions, the coexistence-constrained device 210a and the coexistence-constrained device 210b may renegotiate to adjust the frame size accordingly to maintain efficient communication. This approach facilitates that communication remains reliable and adapted to the specific capabilities of each device involved.

In one or more implementations, the frame size negotiation between the coexistence-constrained device 210a and the coexistence-constrained device 210b may utilize 6loWPAN headers and command frames. Each of the coexistence-constrained device 210a and the coexistence-constrained device 210b may maintain a local frame size (LFS) setting that tracks the frame size capability of the local device and a remote frame size (RFS) setting that tracks the frame size capability of the remove device. Upon establishing or re-establishing a connection, both the LFS and RFS settings can be set to 127 bytes. When the overall coexistence conditions improve on the local device, the LFS setting may be updated to a new frame size, and any pending transmission frames may use this new frame size. On the other coexistence-constrained device, upon receiving a packet, the device may determine if there is an update to the frame size and subsequently updates its RFS setting with the new frame size. In one or more other implementations, if there are no outgoing packets, a command frame can be used to indicate the new frame size.

As illustrated in FIG. 7, the coexistence-constrained device 210a initially has a LFS limit of 127 bytes and the coexistence-constrained device 210b initially has a LFS limit of 100 bytes. In this regard, the coexistence-constrained device 210a may set its RFS setting to 100 bytes to reflect the coexistence-constrained device 210b's frame size capability and the coexistence-constrained device 210b may set its RFS setting to 127 bytes to reflect the coexistence-constrained device 210a's frame size capability. If the coexistence-constrained device 210a can only handle frames up to 90 bytes due to coexistence constraints, the coexistence-constrained device 210a may communicate this limitation using a MAC command and updates its LFS setting to 90 byes. For example, at 702, the coexistence-constrained device 210a sends a MAC command to the coexistence-constrained device 210b. At 704, the coexistence-constrained device 210b receives the MAC command. In one or more other implementations, the coexistence-constrained device 210a sends a MLE message to the coexistence-constrained device 210b, the coexistence-constrained device 210b receives the MLE message. Upon receiving this information, the coexistence-constrained device 210b can adjust its RFS setting to 90 bytes, aligning with the coexistence-constrained device 210a frame size capability. At 706, the coexistence-constrained device 210b sends an acknowledgment message to the coexistence-constrained device 210a. At 708, the coexistence-constrained device 210a receives the acknowledgment message. Both coexistence-constrained devices then operate with a mutually agreed frame size of 90 bytes for subsequent data exchanges.

If coexistence conditions change later and the coexistence-constrained device 210a can handle frame sizes up to 127 bytes, it may send a request to update the coexistence-constrained device 210b using a MAC command or MLE message. In response, the coexistence-constrained device 210a may increase its LFS setting to 127 bytes while maintaining its RFS setting at 100 bytes. For example, at 710, the coexistence-constrained device 210a sends a MAC command indicating a frame size adjustment to 127 bytes. At 712, the coexistence-constrained device 210b receives the MAC command. In response, the coexistence-constrained device 210b may increase its RFS setting to 127 bytes while maintaining its LFS setting at 100 bytes. This adjustment allows them to utilize the larger frame size of 127 bytes when communication requirements allow, effectively managing their coexistence constraints while optimizing data transmission efficiency within the network. At 714, the coexistence-constrained device 210b sends an acknowledgment message to the coexistence-constrained device 210a. At 716, the coexistence-constrained device 210a receives the acknowledgment message. Both coexistence-constrained devices then operate with a mutually agreed frame size of 100 bytes for subsequent data exchanges.

If coexistence conditions change again later and the coexistence-constrained device 210b can handle frame sizes up to 127 bytes, it may send a request to update the coexistence-constrained device 210a using a MAC command or MLE message. In response, the coexistence-constrained device 210b may increase its LFS setting to 127 bytes while maintaining its RFS setting at 127 bytes. For example, at 718, the coexistence-constrained device 210b sends a MAC command indicating a frame size adjustment to 127 bytes. At 720, the coexistence-constrained device 210a receives the MAC command. In response, the coexistence-constrained device 210a may increase its RFS setting to 127 bytes while maintaining its LFS setting at 127 bytes. This adjustment allows them to utilize the larger frame size of 127 bytes when communication requirements allow, effectively managing their coexistence constraints while optimizing data transmission efficiency within the network. At 722, the coexistence-constrained device 210a sends an acknowledgment message to the coexistence-constrained device 210b. At 724, the coexistence-constrained device 210b receives the acknowledgment message. Both coexistence-constrained devices then operate with a mutually agreed frame size of 127 bytes for subsequent data exchanges.

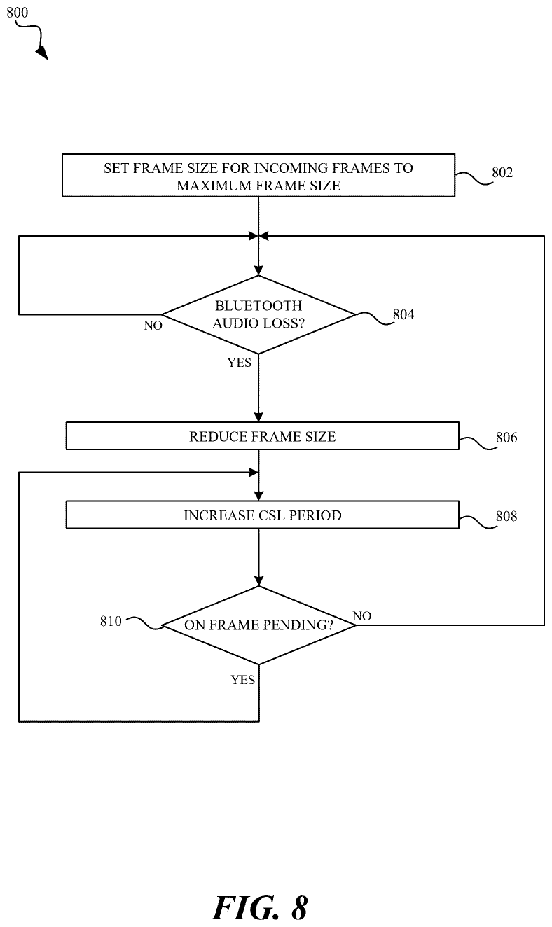

FIG. 8 is a flow chart of an example process 800 of an example dynamic frame size adaptation procedure based on audio loss feedback in accordance with one or more implementations. At block 802, a coexistence-constrained device (e.g., the coexistence-constrained device 210; 210a; 210b) may set a frame size for incoming frames to a maximum frame size value (e.g., 127 bytes). In one or more implementations, the coexistence-constrained device that functions as a SED or SSED may involve adjusting frame sizes dynamically based on Bluetooth audio activity. For SSEDs, adjustments to an incoming frame size can be based on real-time Bluetooth audio loss feedback. At 804, if no audio loss is detected, the coexistence-constrained device maintains the current frame size suitable for applications. In one or more other implementations, for profiles such as BLE used in hearing aids, packet loss may occur, necessitating reduction in frame size to prevent data loss. The coexistence-constrained device may adapt by reducing its frame sizes incrementally until packets fit without loss, considering Bluetooth slot durations. Referring back to decision 804, if audio loss is detected, the process 800 proceeds to block 806. At block 806, the coexistence-constrained device may reduce its frame size to mitigate Bluetooth interference. At block 808, the coexistence-constrained device may increase the CSL period. In one or more implementations SSEDs may adjust frame sizes and/or CSL periods when managing Bluetooth audio loss.

In one or more implementations, SSEDs, as a receiver, may anticipate incoming frames and set a frame pending bit to initiate data polling for additional data. In one or more other implementations, data polling increases Bluetooth interference, affecting audio quality. To mitigate this, the coexistence-constrained device may adjust the CSL period to reduce polling frequency and control Bluetooth interference. For example, at 810, the coexistence-constrained device may determine whether a frame is pending. If a frame is pending, the process 800 proceeds back to block 808 to increase the CSL period. Otherwise, the process 800 proceeds back to 804. In one or more other implementations, due to mesh network protocol constraints, the minimum header size of about 50 bytes can limit by how much the frame size can be reduced. Even with a minimal payload of about zero bytes, a data packet fragment may still consume significant airtime, approximately 2 ms. In one or more other implementations, attempting to decrease the frame size below approximately 70 bytes may not effectively reduce Bluetooth interference, as the Bluetooth audio loss may persist despite these frame size adjustments. As such, a coexistence-constrained device may increase a CSL period up to 480 ms while maintaining the frame size to about the maximum frame size that the coexistence-constrained device can support to help mitigate Bluetooth audio losses effectively.

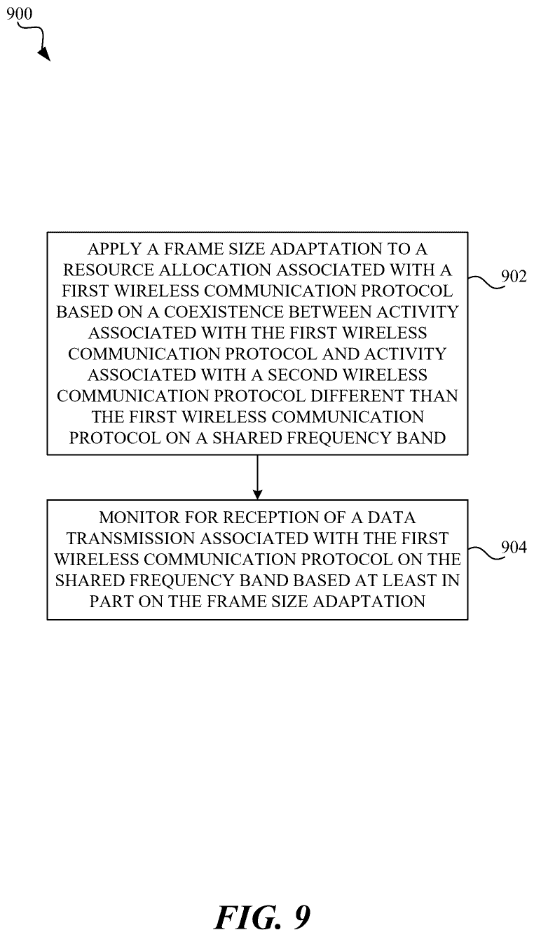

FIG. 9 is a schematic diagram illustrating an example process 900 for dynamic frame size adaptation by a coexistence-constrained device in accordance with one or more implementations. For explanatory purposes, the process 900 is primarily described herein with reference to an apparatus. However, the process 900 is not limited to the apparatus, and one or more blocks (or operations) of the process 900 may be performed by one or more other components of other suitable devices and/or servers. Further for explanatory purposes, some of the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

In one or more implementations, the apparatus of FIG. 9 includes a mesh network processor (e.g., mesh network processing circuitry 234 of FIG. 2) coupled to a RF transceiver (e.g., one or more transceivers 216 of FIG. 2). The apparatus communicates using the mesh network processor through the RF transceiver with other coexistence-constrained devices and/or non-coexistence-constrained devices. In one or more implementations, the apparatus is the entire coexistence-constrained device (e.g., coexistence-constrained device 210) and includes additional radios (e.g., cellular processing circuitry 212, Bluetooth processing circuitry 211, WLAN processing circuitry 219, mesh network processing circuitry 234).

At block 902, the apparatus may apply one or more dynamic frame size adaptation to a resource allocation associated with the first wireless communication protocol based on a coexistence between activity associated with the first wireless communication protocol and activity associated with a second wireless communication protocol different than the first wireless communication protocol on a shared frequency band.

In one or more implementations, the apparatus may apply the one or more frame size adaptation by indicating an adjustment to a frame size from a first frame size to a second frame size different from the first frame size for data transmissions to the apparatus based on the coexistence between the activity associated with the first wireless communication protocol and the activity associated with the second wireless communication protocol. In one or more other implementations, the apparatus may detect a change in the coexistence between the activity associated with the first wireless communication protocol and the activity associated with the second wireless communication protocol. The apparatus may indicate another adjustment to the frame size from the second frame size to a third frame size different from the second frame size for data transmissions to the apparatus based on the detected change in the coexistence. In one or more implementations, the apparatus may receive, from a non-coexistence-constrained device (e.g., the non-coexistence-constrained device 220), a data frame having a frame size that corresponds to the third frame size. The apparatus may provide an acknowledgment message for transmission to the non-coexistence-constrained device 220 in response to reception of the data frame.

In one or more other implementations, the apparatus may apply the one or more frame size adaptation by providing an acknowledgment message for transmission to the non-coexistence-constrained device 220 in response to a data frame transmission from the non-coexistence-constrained device, the acknowledgment message comprising an information element indicating the adjustment to the frame size for data transmissions to the apparatus.

In one or more other implementations, the apparatus may apply the one or more frame size adaptation by providing a data frame for transmission to the non-coexistence-constrained device 220, the data frame comprising an information element indicating the adjustment to the frame size for data transmissions to the apparatus.

In one or more other implementations, the apparatus may apply the one or more frame size adaptation by providing a data poll message for transmission to the non-coexistence-constrained device 220. In some aspects, the data poll message includes an information element indicating the adjustment to the frame size for data transmissions to the apparatus.

In one or more other implementations, the apparatus may apply the one or more frame size adaptation by providing a MAC command for transmission the non-coexistence-constrained device 220. In some aspects, the MAC command indicates the adjustment to the frame size for data transmissions to the apparatus. In one or more implementations, the MAC command is transmitted through a broadcast to a plurality of non-coexistence-constrained devices. In one or more other implementations, the MAC command is transmitted through a unicast to the non-coexistence-constrained device.

In one or more other implementations, the apparatus may apply the one or more frame size adaptation by providing a MLE advertisement for transmission to a non-coexistence-constrained device. In some aspects, the MLE advertisement includes a TLV encoding that indicates the adjustment to the frame size for data transmissions to the apparatus.

In one or more other implementations, the apparatus may apply the one or more frame size adaptation by indicating an adjustment to a frame size from a first frame size to a second frame size different from the first frame size for data transmissions to the apparatus. In some aspects, the adjustment to the frame size is indicated by a TLV encoding in one or more of a MLE message, a keep-alive message, or a child device supervision message.

In one or more other implementations, the apparatus may apply the one or more frame size adaptation by providing a MAC data frame for transmission to a non-coexistence-constrained device. In some aspects, the MAC data frame includes a fragmentation header indicating the adjustment to the frame size for data transmissions to the apparatus. In one or more implementations, the fragmentation header is included in each of a plurality of fragments associated with the MAC data frame. In some aspects, the fragmentation header for each of the plurality of fragments indicates a tag common between each of the plurality of fragments and the frame size with the adjustment. In other aspects, the fragmentation header for one or more fragments of the plurality of fragments after a first fragment of the plurality of fragments includes an offset indicating a position of a fragment within the plurality of fragments.

In one or more other implementations, the apparatus may detect a change in the coexistence between the activity associated with the first wireless communication protocol and the activity associated with the second wireless communication protocol. The apparatus may provide an indication for transmission to another coexistence-constrained device (e.g., the coexistence-constrained device 220B) based on the detected change in the coexistence. In some aspects, the indication may indicate an adjustment to a frame size from a first frame size to a second frame size different from the first frame size for data transmissions to the apparatus. The apparatus may receive, from the coexistence-constrained device, an acknowledgment message in response to transmission of the indication, the acknowledgment message indicating acknowledgment of the second frame size by the coexistence-constrained device. The apparatus may adjust a LFS parameter to a value corresponding to the second frame size. In one or more implementations, the indication is provided for transmission to the coexistence-constrained device in a MAC command or a MLE advertisement based on a determination that no data transmission is pending to the coexistence-constrained device. In one or more other implementations, the indication is provided for transmission to the coexistence-constrained device in one or more fragmentation headers of a MAC data frame based on a determination that a data transmission is pending to the coexistence-constrained device.

In one or more other implementations, the apparatus may receive, from a coexistence-constrained device (e.g., the coexistence-constrained device 220B), an indication indicating an adjustment to a frame size from a first frame size to a second frame size different from the first frame size for data transmissions to the coexistence-constrained device. The apparatus may provide an acknowledgment message for transmission to the coexistence-constrained device in response to the received indication. In some aspects, the acknowledgment message indicates acknowledgment of the second frame size by the apparatus. The apparatus may adjust a RFS parameter associated with the coexistence-constrained device to a value corresponding to the second frame size.

In one or more other implementations, the apparatus may set a LFS parameter to a first frame size value corresponding to a maximum frame size. The apparatus may determine whether a feedback signal associated with the second wireless communication protocol indicates a loss in audio packets associated with the second wireless communication protocol. The apparatus may adjust one or more of the LFS parameter from the first frame size value to a second frame size value smaller than the first frame size value or a CSL period based on a determination that the feedback signal indicates a loss in audio packets associated with the second wireless communication protocol.

At block 904, the apparatus may monitor for reception of a data transmission associated with the first wireless communication protocol on the shared frequency band based at least in part on the one or more frame size adaptation. In one or more implementations, the apparatus may receive, from the non-coexistence-constrained device 220, a data frame having a frame size that corresponds to the second frame size. The apparatus may provide an acknowledgment message for transmission to the non-coexistence-constrained device 220 in response to reception of the data frame.

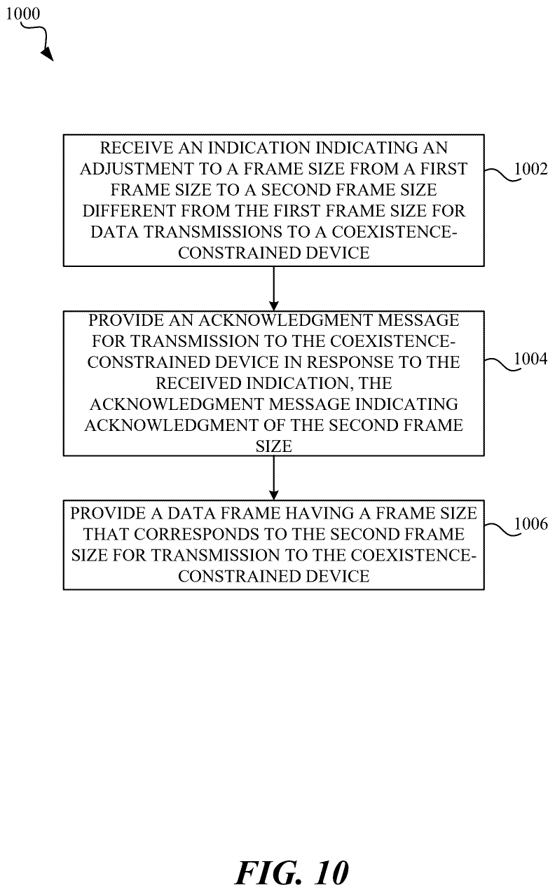

FIG. 10 is a schematic diagram illustrating an example process 1000 for dynamic frame size adaptation by a non-coexistence-constrained device in accordance with one or more implementations. For explanatory purposes, the process 1000 is primarily described herein with reference to the an apparatus. However, the process 1000 is not limited to the apparatus, and one or more blocks (or operations) of the process 1000 may be performed by one or more other components of other suitable devices and/or servers. Further for explanatory purposes, some of the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

In one or more implementations, the apparatus of FIG. 10 includes a mesh network processor (e.g., mesh network processing circuitry 236 of FIG. 2) coupled to a RF transceiver (e.g., one or more transceivers 226 of FIG. 2). The apparatus communicates using the mesh network processor through the RF transceiver with other end devices and/or routers. In one or more implementations, the apparatus is the entire non-coexistence-constrained device (e.g., the non-coexistence-constrained device 220).

As illustrated in FIG. 10, at block 1002, the apparatus may receive an indication indicating an adjustment to a frame size from a first frame size to a second frame size different from the first frame size for data transmissions to a coexistence-constrained device (e.g., the coexistence-constrained device 210).

At block 1004, the apparatus may provide an acknowledgment message for transmission to the coexistence-constrained device 210 in response to the received indication. In some aspects, the acknowledgment message may indicate acknowledgment of the second frame size.

At block 1006, the apparatus may provide a data frame having a frame size that corresponds to the second frame size for transmission to the coexistence-constrained device 210. In this regard, the apparatus can adjust the frame size to optimize the coexistence between radios sharing the same frequency band.

FIG. 11 illustrates an electronic system 1100 with which one or more implementations of the subject technology may be implemented. The electronic system 1100 can be, and/or can be a part of, any one of the electronic devices 110-112 and/or the server 120 shown in FIG. 1; the coexistence-constrained device 210 and/or the non-coexistence constrained device 210 shown in FIG. 2; the coexistence-constrained device 210 and/or the non-coexistence constrained device 220 shown in FIG. 3; the coexistence-constrained device 210 and/or the non-coexistence constrained device 220 shown in FIGS. 4A-4C; the coexistence-constrained device 210, the non-coexistence constrained device 220a and/or the non-coexistence constrained device 220b shown in FIG. 5; the coexistence-constrained device 210a and/or the coexistence-constrained device 210b shown in FIG. 7. The electronic system 1100 may include various types of computer readable media and interfaces for various other types of computer readable media. The electronic system 1100 includes a bus 1108, one or more processing unit(s) 1112, a system memory 1104 (and/or buffer), a ROM 1110, a permanent storage device 1102, an input device interface 1114, an output device interface 1106, and one or more network interfaces 1116, or subsets and variations thereof.

The bus 1108 collectively represents all system, peripheral, and chipset buses that communicatively connect the numerous internal devices of the electronic system 1100. In one or more implementations, the bus 1108 communicatively connects the one or more processing unit(s) 1112 with the ROM 1110, the system memory 1104, and the permanent storage device 1102. From these various memory units, the one or more processing unit(s) 1112 retrieves instructions to execute and data to process in order to execute the processes of the subject disclosure. The one or more processing unit(s) 1112 can be a single processor or a multi-core processor in different implementations.

The ROM 1110 stores static data and instructions that are needed by the one or more processing unit(s) 1112 and other modules of the electronic system 1100. The permanent storage device 1102, on the other hand, may be a read-and-write memory device. The permanent storage device 1102 may be a non-volatile memory unit that stores instructions and data even when the electronic system 1100 is off. In one or more implementations, a mass-storage device (such as a magnetic or optical disk and its corresponding disk drive) may be used as the permanent storage device 1102.

In one or more implementations, a removable storage device (such as a flash drive, and its corresponding solid-state drive) may be used as the permanent storage device 1102. Like the permanent storage device 1102, the system memory 1104 may be a read-and-write memory device. However, unlike the permanent storage device 1102, the system memory 1104 may be a volatile read-and-write memory, such as random-access memory. The system memory 1104 may store any of the instructions and data that one or more processing unit(s) 1112 may need at runtime. In one or more implementations, the processes of the subject disclosure are stored in the system memory 1104, the permanent storage device 1102, and/or the ROM 1110. From these various memory units, the one or more processing unit(s) 1112 retrieves instructions to execute and data to process in order to execute the processes of one or more implementations.

The bus 1108 also connects to the input device interface 1114 and output device interface 1106. The input device interface 1114 enables a user to communicate information and select commands to the electronic system 1100. Input devices that may be used with the input device interface 1114 may include, for example, alphanumeric keyboards and pointing devices (also called “cursor control devices”). The output device interface 1106 may enable, for example, the display of images generated by electronic system 1100. Output devices that may be used with the output device interface 1106 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 11, the bus 1108 also couples the electronic system 1100 to one or more networks and/or to one or more network nodes, such as the electronic device 110 shown in FIG. 1, through the one or more network interface(s) 1116. In this manner, the electronic system 1100 can be a part of a network of computers (such as a LAN, a wide area network (“WAN”), or an Intranet, or a network of networks, such as the Internet. Any or all components of the electronic system 1100 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “router”, “end device”, “transceiver”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus comprising:
processing circuitry configured to perform operations comprising:
applying a frame size adaptation to a resource allocation associated with a first wireless communication protocol based on a coexistence between activity associated with the first wireless communication protocol and activity associated with a second wireless communication protocol different than the first wireless communication protocol on a shared frequency band; and
monitoring for reception of a data transmission associated with the first wireless communication protocol on the shared frequency band based at least in part on the frame size adaptation.

2. The apparatus of claim 1, wherein applying the frame size adaptation comprises indicating an adjustment to a frame size from a first frame size to a second frame size different from the first frame size for data transmissions to the apparatus based on the coexistence between the activity associated with the first wireless communication protocol and the activity associated with the second wireless communication protocol.

3. The apparatus of claim 2, wherein the operations further comprise:
receiving, from a non-coexistence-constrained device, a data frame comprising a frame size that corresponds to the second frame size; and
providing an acknowledgment message for transmission to the non-coexistence-constrained device in response to reception of the data frame.

4. The apparatus of claim 2, wherein the operations further comprise:
detecting a change in the coexistence between the activity associated with the first wireless communication protocol and the activity associated with the second wireless communication protocol; and
indicating another adjustment to the frame size from the second frame size to a third frame size different from the second frame size for data transmissions to the apparatus based on the detected change in the coexistence.

5. The apparatus of claim 4, wherein the operations further comprise:
receiving, from a non-coexistence-constrained device, a data frame comprising a frame size that corresponds to the third frame size; and
providing an acknowledgment message for transmission to the non-coexistence-constrained device in response to reception of the data frame.

6. The apparatus of claim 2, wherein applying the frame size adaptation comprises providing an acknowledgment message for transmission to a non-coexistence-constrained device in response to a data frame transmission from the non-coexistence-constrained device, the acknowledgment message comprising an information element indicating the adjustment to the frame size for data transmissions to the apparatus.

7. The apparatus of claim 2, wherein applying the frame size adaptation comprises providing a data frame for transmission to a non-coexistence-constrained device, the data frame comprising an information element indicating the adjustment to the frame size for data transmissions to the apparatus.

8. The apparatus of claim 2, wherein applying the frame size adaptation comprises providing a data poll message for transmission to a non-coexistence-constrained device, the data poll message comprising an information element indicating the adjustment to the frame size for data transmissions to the apparatus.

9. The apparatus of claim 2, wherein applying the frame size adaptation comprises providing a medium access control (MAC) command for transmission to a non-coexistence-constrained device, the MAC command indicating the adjustment to the frame size for data transmissions to the apparatus.

10. The apparatus of claim 9, wherein the MAC command is transmitted through a broadcast to a plurality of non-coexistence-constrained devices.

11. The apparatus of claim 9, wherein the MAC command is transmitted through a unicast to the non-coexistence-constrained device.

12. The apparatus of claim 2, wherein applying the frame size adaptation comprises providing a mesh link establishment (MLE) advertisement for transmission to a non-coexistence-constrained device, the MLE advertisement comprising a type-length-value (TLV) encoding that indicates the adjustment to the frame size for data transmissions to the apparatus.

13. The apparatus of claim 2, wherein applying the frame size adaptation comprises indicating an adjustment to a frame size from a first frame size to a second frame size different from the first frame size for data transmissions to the apparatus, the adjustment to the frame size being indicated by a type-length-value (TLV) encoding in one or more of a mesh link establishment (MLE) message, a keep-alive message, or a child device supervision message.

14. The apparatus of claim 2, wherein applying the frame size adaptation comprises providing a medium access control (MAC) data frame for transmission to a non-coexistence-constrained device, the MAC data frame comprising a fragmentation header indicating the adjustment to the frame size for data transmissions to the apparatus.

15. The apparatus of claim 14, wherein the fragmentation header is included in each of a plurality of fragments associated with the MAC data frame, wherein the fragmentation header for each of the plurality of fragments indicates a tag common between each of the plurality of fragments and the frame size with the adjustment, and wherein the fragmentation header for one or more fragments of the plurality of fragments after a first fragment of the plurality of fragments includes an offset indicating a position of a fragment within the plurality of fragments.

16. The apparatus of claim 2, wherein the operations further comprise:
detecting a change in the coexistence between the activity associated with the first wireless communication protocol and the activity associated with the second wireless communication protocol;
providing an indication for transmission to a coexistence-constrained device based on the detected change in the coexistence, the indication indicating an adjustment to a frame size from a first frame size to a second frame size different from the first frame size for data transmissions to the apparatus;
receiving, from the coexistence-constrained device, an acknowledgment message in response to transmission of the indication, the acknowledgment message indicating acknowledgment of the second frame size by the coexistence-constrained device; and
adjusting a local frame size (LFS) parameter to a value corresponding to the second frame size.

17. The apparatus of claim 16, wherein the indication is provided for transmission to the coexistence-constrained device in a medium access control (MAC) command or a mesh link establishment (MLE) advertisement based on a determination that no data transmission is pending to the coexistence-constrained device, and wherein the indication is provided for transmission to the coexistence-constrained device in one or more fragmentation headers of a MAC data frame based on a determination that a data transmission is pending to the coexistence-constrained device.

18. The apparatus of claim 2, wherein the operations further comprise:
receiving, from a coexistence-constrained device, an indication indicating an adjustment to a frame size from a first frame size to a second frame size different from the first frame size for data transmissions to the coexistence-constrained device;
providing an acknowledgment message for transmission to the coexistence-constrained device in response to the received indication, the acknowledgment message indicating acknowledgment of the second frame size by the apparatus; and
adjusting a remote frame size (RFS) parameter associated with the coexistence-constrained device to a value corresponding to the second frame size.

19. The apparatus of claim 2, wherein the operations further comprise:
setting a local frame size (LFS) parameter to a first frame size value corresponding to a maximum frame size;
determining whether a feedback signal associated with the second wireless communication protocol indicates a loss in audio packets associated with the second wireless communication protocol; and
adjusting one or more of the LFS parameter from the first frame size value to a second frame size value smaller than the first frame size value or a coordinated sampled listening (CSL) period based on a determination that the feedback signal indicates a loss in audio packets associated with the second wireless communication protocol.

20. A method comprising:
applying frame size adaptation to a resource allocation associated with a first wireless communication protocol based on a coexistence between activity associated with the first wireless communication protocol and activity associated with a second wireless communication protocol different than the first wireless communication protocol on a shared frequency band; and
monitoring for reception of a data transmission associated with the first wireless communication protocol on the shared frequency band based at least in part on the frame size adaptation.

21. A non-transitory computer-readable medium comprising code that, when executed by a processor, causes the processor to perform operations comprising:
applying frame size adaptation to a resource allocation associated with a first wireless communication protocol based on a coexistence between activity associated with the first wireless communication protocol and activity associated with a second wireless communication protocol different than the first wireless communication protocol on a shared frequency band; and
monitoring for reception of a data transmission associated with the first wireless communication protocol on the shared frequency band based at least in part on the frame size adaptation.
